(19) United States
(12) Patent Application Publication
(10) Pub. No.: US 2024/0051753 A1
(43) Pub. Date: Feb. 15, 2024

(54) SUSPENDED AUTOMATION SYSTEM

(71) Applicant: Kenneth C. Miller, Aptos, CA (US)

(72) Inventor: Kenneth C. Miller, Aptos, CA (US)

(21) Appl. No.: 18/267,473

(22) PCT Filed: Dec. 15, 2021
(86) PCT No.: PCT/US2021/063449

§ 371 Date: Jun. 15, 2023

Related U.S. Application Data
(60) Provisional application No. 63/125,592, filed on Dec. 15, 2020.

(51) Int. Cl. B65G 1/137; B65G 1/04

(52) U.S. Cl. CPC B65G 1/1371; B65G 1/0464

(57) ABSTRACT

A suspended automation system includes a rail array secured to a ceiling. A gantry moves in an X-Y plane defined by the rail array with a drive mechanism. A controller with a human or computer user interface allows for selective movement of the gantry to transport, and in some instances store or manipulate articles. A motorized rotating platform and one or more of a robotic arm, a camera, or a counter-balance are added to the platform to facilitate storage, manipulation, and/or actions in the area below the ceiling. A rail array in some embodiments is equipped with storage modules located above the rail array that can take a variety of shapes, sizes, and configurations for storage of an article, including a stack of trays. A related process of article movement can be accomplished by the suspended automation system. Another related process is overhead storage and selective delivery of an article.

### RELATED APPLICATIONS

This application claims priority benefit of U.S. Provisional Application Ser. No. 63/125,592, filed Dec. 15, 2020 the contents of which are herby incorporated by reference.

### FIELD OF THE INVENTION

The present invention in general relates to an automated system and in particular for a ceiling mounted interior space automated construction, maintenance, storage, logistics, or production system configured with robots and other automation.

### BACKGROUND OF THE INVENTION

Moving typical wheeled, tracked or legged robots around the interior of buildings and from room to room in order to perform household tasks such as setting tables, clearing dishes, washing dishes, putting away dishes, dusting, vacuuming, collecting clothing, washing clothing, cooking, painting, sanding, general maintenance, etc. requires that the robots to be capable of moving around on the floor which may have many obstacles such as thresholds, carpets, steps, stairs, toys, rugs, people, pets, tables, chairs, furniture, etc. that could interfere with the robot's ability to navigate the space. There is also a problem with current robotic systems of not being able to reach above, over and around lamps, furniture, etc. as well as accessing the ceiling. In addition, there is no method for robots to easily transport bins, trays, vacuum systems, washing systems, etc. from room to room in a building while simultaneously performing the aforementioned tasks. There is no current means to provide power to home robotic systems without the use of on-board batteries or cords/tethers. There is currently no solution for ceiling mounted automation systems to move robots from room to room due to the header above doorways.

Additionally, as population densities increase globally, living spaces are expected to shrink. Much of the required space in a living setting is devoted to storage of articles. The ability to access articles and appliances without having devoted floor space for such storage would greatly facilitate shrinking personal living space.

Furthermore, as the use of drone technology becomes more widespread, new uses for drones are being developed. By way of non-limiting example, in the commercial sector companies are exploring the use of drones to deliver mail, food, and medical supplies to homes. A variety of factors make such use of drone technology difficult if not impossible. Various home designs often make access to the front porch or other safe delivery point via drone difficult or impossible. Drones are unable to access interior portions of many apartment buildings thereby precluding front-door delivery. In the case of medicine delivery, even if a front porch or other safe delivery point is accessible, delivering medication in such an unsecured fashion is not ideal for a many reasons including an increased risk of theft. The ability to securely deliver articles to an area of a building more easily accessible to a drone, for example a receptacle on rooftop also accessible via the interior of the building, would greatly facilitate the effective use of drones in streams of commerce.

Thus, there exists a need for an improved robotic automation systems for covered and interior spaces. There also exists a need for such a system to store, retrieve and manipulate articles in the interior space without devoted floor space usage.

### SUMMARY OF THE INVENTION

A suspended automation system includes a rail array secured to a ceiling. A gantry moves in an X-Y plane defined by the rail array with a drive mechanism. A controller with a human user interface allows for selective movement of the gantry to transport, and in some instances store or manipulate articles. A human user interface can be a display, touch screen tablet, auditory, smart phone, or a joystick.

A motorized rotating platform and one or more multiple degree of freedom robotic arms, one or more cameras, or one or more motorized counter-balances are added to the platform to facilitate storage and manipulation, as well as actions with the area below the ceiling. A rail array in some inventive embodiments is equipped with storage modules located above the rail array, the storage modules can take a variety of shapes, sizes, and configurations for storage of an article, including in some inventive embodiments a stack of storage modules. The article is lowered and transported from the storage module by the gantry to the platform.

A related process is also provided that includes actions and article transport. Construction of walls or objects under the ceiling, painting, cleaning, and food preparation are some of the tasks that can be accomplished by the suspended automation system. Still another related process is overhead storage and selective delivery of an article. The article is amenable to manipulation in transit to a user selected delivery point through the actions of one or more robotic arms, equipped with variable tools.

### BRIEF DESCRIPTION OF THE DRAWINGS

The present invention is further detailed with respect to the following figures that depict various aspects of the present invention.

FIG. 1 illustrates a wire supported X-Y-Z gantry system in accordance with certain embodiments of the invention;

FIG. 2 illustrate the wire supported X-Y-Z gantry system of FIG. 1 mounted in a room or a walled enclosure in accordance with certain embodiments of the invention;

FIGS. 3A-3C illustrate a series of perspective views of motorized robotic modules for use with the X-Y-Z gantry system of FIG. 1 in accordance with certain embodiments of the invention;

FIG. 4A illustrates a perspective view of the wire supported X-Y-Z gantry system of FIG. 1 outfitted with a motorized robotic module in accordance with certain embodiments of the invention;

FIG. 4B illustrates a perspective view of the wire supported X-Y-Z gantry system of FIG. 1 outfitted with a motorized robotic module with additional platforms suspended from the motorized robotic module from the auxiliary rails in accordance with certain embodiments of the invention;

FIG. 5 illustrates the wire supported X-Y-Z gantry system configured with the additional platforms of FIG. 4B mounted in a room or a walled enclosure in accordance with certain embodiments of the invention;

FIG. 6 illustrates adjoining rooms or enclosures with separate X-Y-Z gantry systems in accordance with certain embodiments of the invention;

FIG. 7 illustrates the transfer between the adjoined rooms of FIG. 6 with the alignment of the extension rails in accordance with certain embodiments of the invention;

FIG. 8 is a perspective view of the supported platforms and the alignment of the extension rails for transfer of the motorized robotic module in accordance with certain embodiments of the invention;

FIGS. 9A-9C illustrate the progress of the transferring of the motorized robotic module between wire supported X-Y-Z gantry systems of adjoining rooms or enclosures in accordance with certain embodiments of the invention;

FIGS. 10A and 10B illustrate a ceiling mounted X-Y rail systems in a room or enclosure in accordance with certain embodiments of the invention, with a magnified view thereof illustrated in FIG. 10B;

FIGS. 11A and 11B are sequential side views of a gantry engaged in the X-Y rail system in accordance with certain embodiments of the invention in translating in the plane of the page (FIG. 11A) and orthogonal to the plane of the page after one rail of in-plane translation (FIG. 11B);

FIG. 12 is a perspective view of platforms A, B, and C with the four drive wheel modules and four lift bars shown on the upper surface of a gantry in accordance with certain embodiments of the invention;

FIG. 13 is a side cut away view of a gantry showing the actuator motor for turning the drive wheel modules and the motorized winches that drive the cables up and down in accordance with certain embodiments of the invention;

FIGS. 14A-14C are a detail views of the actuator motor and gear train for turning the drive wheel modules in accordance with certain embodiments of the invention;

FIG. 15 is a perspective view of the lift bar show the gears, cam and rollers that drive the up and down and turning action of the lift bars in accordance with certain embodiments of the invention;

FIGS. 16A-16I are a series of sequential side views showing the X-Y rail and the actions of the lift bar and drive wheel module in accordance with certain embodiments of the invention;

FIGS. 17A and 17B illustrate a ceiling mounted X-Y rail systems in a room or enclosure in accordance with certain embodiments of the invention, with the magnified view of FIG. 17B showing platform C supporting one or more multiple degree of freedom (DOF) robotic arms, one or more cameras, and counter balance in accordance with certain embodiments of the invention;

FIG. 18 is a perspective of a round version of a gantry with drive wheel modules and lift bars balance in accordance with certain embodiments of the invention;

FIGS. 19A and 19B are sequential side views of a gantry of FIG. 18 engaged in the X-Y rail system in accordance with certain embodiments of the invention in translating in the plane of the page (FIG. 19A) and orthogonal to the plane of the page after one rail of in-plane translation (FIG. 19B);

FIGS. 20A and 20B are perspective views of a platform showing the camera, counter-balance arm extended and tools with the arms shown retracted and extended, respectively in accordance with certain embodiments of the invention;

FIG. 21 is a perspective view of a ceiling storage modules;

FIGS. 22A and 22B are perspective views of a platform of FIG. 20A suspended below the ceiling units of FIG. 21 with a storage module insert resting on the platform to provide access to the storage unit volume, FIG. 22B is a magnified view of platform drive wheels relative to the rail defining a storage module of FIG. 22A;

FIGS. 23A-23E are views of a storage unit as shown in FIG. 21 as a perspective view (FIG. 23A), a side view (FIG. 23B), a perspective view of the unit frame (FIG. 23C), a side view of the unit frame (FIG. 23D) and a bottom view of the unit frame (FIG. 23E);

FIGS. 24A and 24B are a side view of the wheels of a platform relative to a storage unit (FIG. 24A) and a front view of the wheels of a platform relative to a storage unit (FIG. 24B);

FIG. 25 is a wide front view of the of the wheels of a platform relative to a storage unit with portions of the platform extended below the storage unit;

FIGS. 26A-26C are a series of sequential views of the wheel module of a platform below cosmetic panel/storage platform/module (FIG. 26A), the platform raised by cables to contact the cosmetic panel/storage platform/module (FIG. 26B), and in lift bar lift bar rotated to unlatch Latch (FIG. 26C);

FIG. 27 is a side view of ceiling storage module with platforms B/C suspended from the cables;

FIGS. 28A and 28B are perspective views of the system of storage modules and platforms shown in FIG. 27 (FIG. 28A) and a magnified view of the platform and wheel module (FIG. 28B);

FIG. 29 is a perspective views of the system of storage modules and platforms shown in FIG. 27 with arms, cameras, and counterbalances associated with the platform;

FIGS. 30A-30C are a perspective view of a cosmetic panel with an opening to accommodate module C (FIG. 30A), a perspective view of module C with a bottom opening to accommodate internal elevation (FIG. 30B) and a bottom view of module C with a bottom opening (FIG. 30C).

FIGS. 31A and 31B are perspective views of a stack of a plurality of storage modules according to certain embodiments of the invention.

FIGS. 32A and 32B are perspective views of a stack of a plurality of storage modules on a platform suspended from the gantry according to certain embodiments of the invention.

FIGS. 33A and 33B are perspective views of a stack of a plurality of storage modules being retrieved by the gantry according to certain embodiments of the invention.

FIGS. 34A and 34B are perspective views of a retrieved stack of a plurality of storage modules being lowered on a platform suspended by the gantry according to certain embodiments of the invention.

FIG. 35 is a perspective view of one storage module of a stack accessible from a roof of a building through a hatch in the roof shown in transparent view.

FIG. 36 is an exploded perspective view of an inventive delivery system according to certain embodiments of the present invention.

FIG. 37A is a top perspective view of an inventive system according to certain embodiments of the present invention with a platform suspended below an array of ceiling storage module units, the platform being configured for use in a bar or restaurant setting.

FIG. 37B is a bottom perspective view of an inventive system according to certain embodiments of the present invention with a platform suspended below an array of ceiling storage module units, the platform being configured for use in a bar or restaurant setting.

FIGS. 38A and 38B show a bottom perspective view and a top perspective view, respectively, of a ceiling storage module of FIG. 37A.

FIG. 39 is a bottom perspective view of an embodiment of a gantry of FIG. 37A.

FIG. 40 is a perspective view of a platform configured for use in a bar or restaurant setting of FIG. 37A.

FIG. 41 is a perspective view of a beverage storage and dispensing unit of FIG. 37A.

FIG. 42 is a schematic drawing of a loading, unloading, and transfer system according to certain embodiments of the present invention shown in a start position.

FIG. 43 is a schematic drawing of the loading, unloading, and transfer system of FIG. 42 showing a first step of an operation sequence for loading, unloading, and transferring.

FIG. 44 is a schematic drawing of the loading, unloading, and transfer system of FIG. 42 showing a second step of an operation sequence for loading, unloading, and transferring.

FIG. 45 is a schematic drawing of the loading, unloading, and transfer system of FIG. 42 showing a third step of an operation sequence for loading, unloading, and transferring.

FIG. 46 is a schematic drawing of the loading, unloading, and transfer system of FIG. 42 showing a fourth step of an operation sequence for loading, unloading, and transferring.

FIG. 47 is a schematic drawing of the loading, unloading, and transfer system of FIG. 42 showing a fifth step of an operation sequence for loading, unloading, and transferring.

FIG. 48 is a schematic drawing of the loading, unloading, and transfer system of FIG. 42 showing a sixth step of an operation sequence for loading, unloading, and transferring.

FIG. 49 is a schematic drawing of the loading, unloading, and transfer system of FIG. 42 showing a seventh step of an operation sequence for loading, unloading, and transferring.

FIG. 50 is a schematic drawing of the loading, unloading, and transfer system of FIG. 42 showing an eighth step of an operation sequence for loading, unloading, and transferring.

FIG. 51 is a schematic drawing of the loading, unloading, and transfer system of FIG. 42 showing a ninth step of an operation sequence for loading, unloading, and transferring.

FIG. 52 is a schematic drawing of the loading, unloading, and transfer system of FIG. 42 showing a tenth step of an operation sequence for loading, unloading, and transferring.

FIG. 53 is a schematic drawing of the loading, unloading, and transfer system of FIG. 42 showing an eleventh step of an operation sequence for loading, unloading, and transferring.

FIG. 54 is a schematic drawing of the loading, unloading, and transfer system of FIG. 42 showing a twelfth step of an operation sequence for loading, unloading, and transferring.

FIG. 55 is a schematic drawing of the loading, unloading, and transfer system of FIG. 42 showing a thirteenth step of an operation sequence for loading, unloading, and transferring.

FIG. 56 is a perspective view of a transfer tunnel and swap shuttle positioned therein according to certain embodiments of the present disclosure.

FIG. 57 is a perspective view of the swap shuttle of FIG. 56.

FIG. 58 shows a perspective view of a tray with a cover according to certain embodiments of the present invention.

FIG. 59 shows a perspective view of the tray of FIG. 58 with the cover removed and tiers of the tray in an expanded position.

FIG. 60 shows a perspective view of the tray of FIG. 58 with the cover removed and tiers of the tray in a retracted position.

FIG. 61 shows a perspective view of the tray of FIG. 58 with the cover removed and tiers of the tray in an expanded position.

FIG. 62 is a perspective view showing a battery positioned within a tray for use with a suspended automation system according to certain embodiments of the present invention.

FIG. 63 is an exploded view of the battery and the tray of FIG. 62.

FIG. 64A shows a top perspective view of a gantry having a cover manipulation system according to certain embodiments of the present invention.

FIG. 64B shows a bottom perspective view of the gantry of FIG. 64A.

FIG. 65A show s bottom view of the gantry of FIG. 64A having a cover manipulation system in a retracted position.

FIG. 65B show s bottom view of the gantry of FIG. 64A having a cover manipulation system in an extended position.

FIGS. 66A-66F are photographs of floor robots according to certain embodiments of the present invention.

FIG. 67A is a photograph of a drink serving unit for use with a floor robot according to certain embodiments of the present invention.

FIG. 67B is a photograph of a food running unit for use with a floor robot according to certain embodiments of the present invention.

FIG. 67C is a photograph of a table bussing unit for use with a floor robot according to certain embodiments of the present invention.

FIGS. 68A and 68B are photographs of an animatronic waiter head for use with a floor or ceiling based robot according to certain embodiments of the present invention.

FIGS. 69A and 69B show a robotic arm in a kitchen setting according to certain embodiments of the present invention.

FIGS. 69C and 69D show a robotic arm in a bar setting according to certain embodiments of the present invention.

FIG. 69E shows a robotic arm in a beverage serving setting such as a bar or café according to certain embodiments of the present invention.

### DESCRIPTION OF THE INVENTION

The present invention has utility as a ceiling mounted automated construction, maintenance, storage, warehousing logistics, bar, restaurant or production system for a covered or interior space configured with robots and other automation. The ceiling defining a portion of an interior room or a trellis that is either indoors or outdoors. Through resort to innovative support systems including an overhead gantry system, cables, or an X-Y rail grid, a suspended platform is traversed throughout the system area.

It should be appreciated that a module according to the present invention provides volume in which articles are stored, an automation sub-system that performs a function or delivers articles to a user or a combination of both storage and function. The details of which are provided below. It should further be appreciated that modules are operative independent of robotic arms in some inventive embodiments.

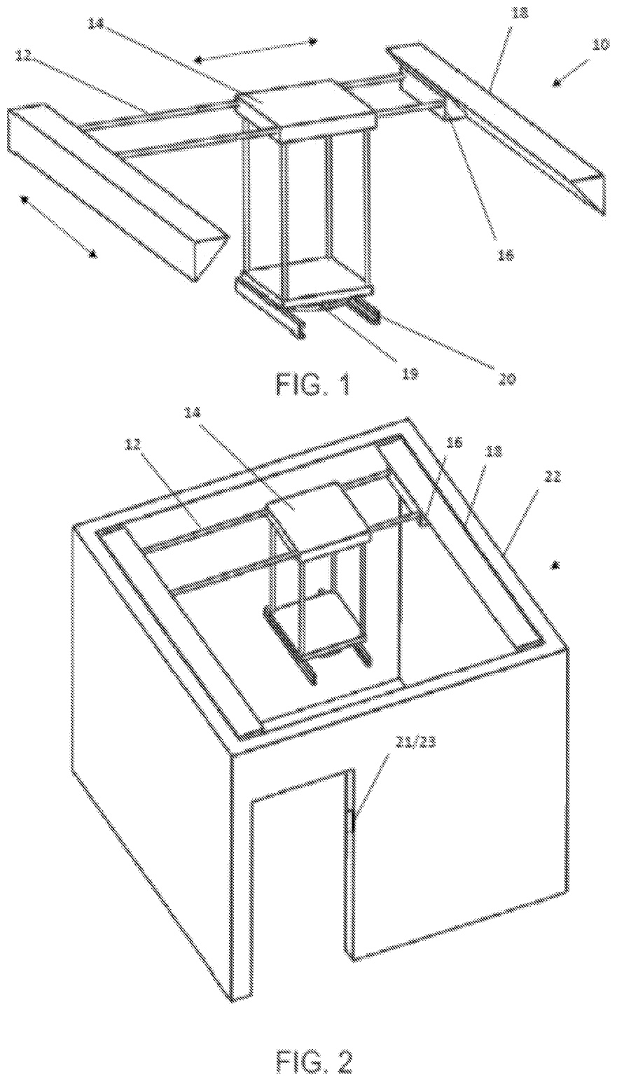

Referring now to the figures, in a first inventive embodiment, an over-head X-Y-Z gantry system 10 is shown in FIG. 1 as a wire 12 supported gantry 14. The wires 12 are attached on opposing sides to slides 16 that ride on side rails 18. As indicated by the bidirectional arrows, the gantry cars 14 move from side to side along the support wires 12, and back and forth from front to back via the slides 16, thereby providing a full set of movement in the x-y plane. Power may be supplied to the gantry cars 14 through the support wire 12. Gantry 14 may be used to support almost any electronic equipment; illustratively including lights, stereo components, speakers, smoke detectors, security systems, laser systems, modems, routers, computers, and combinations thereof.

FIG. 2 illustrates a room or enclosure 22 outfitted with the X-Y-Z gantry system 10 that carries a rotating platform capable to reach most any point in the volume of the room—wall to wall and floor to ceiling where like numerals have the meaning ascribed to thereto with respect to the aforementioned drawing. Extension rails 20 on the gantry cars 14 extend out to mate with corresponding rails on other gantry 14 in other rooms. The extension rails 20 are mounted to a swivel plate 19 that provides for a complete rotation of the extension rails 20 and anything attached to the extension rails 20. A controller 21 includes a computer system and provides a human user interface 23 that is a display, touch screen tablet, auditory, smart phone, or a joystick that receives user input as to the desired articles from storage, the location of delivery and the scheduling of delivery. The controller 21 then instructs the movement of the gantry system 10 to retrieve or store articles. The controller 21 also provides manipulation instructions to a robotic module 24 as to desired actions. Exemplary actions include room construction, painting, sweeping the floor, and cleaning the room. Each robotic arm contains an interface at the distal end for a variety of interchangeable motorized tools (graspers, hands, drills, suction cups, etc.). Each arm supplies electrical power to the various tools. Sensors are routinely associated with a robotic arm, as is conventional to the art, to provide telemetry, grasp strength, and article manipulation feedback data to a controller 21 or a human user of the controller 21 via the human interface 23.

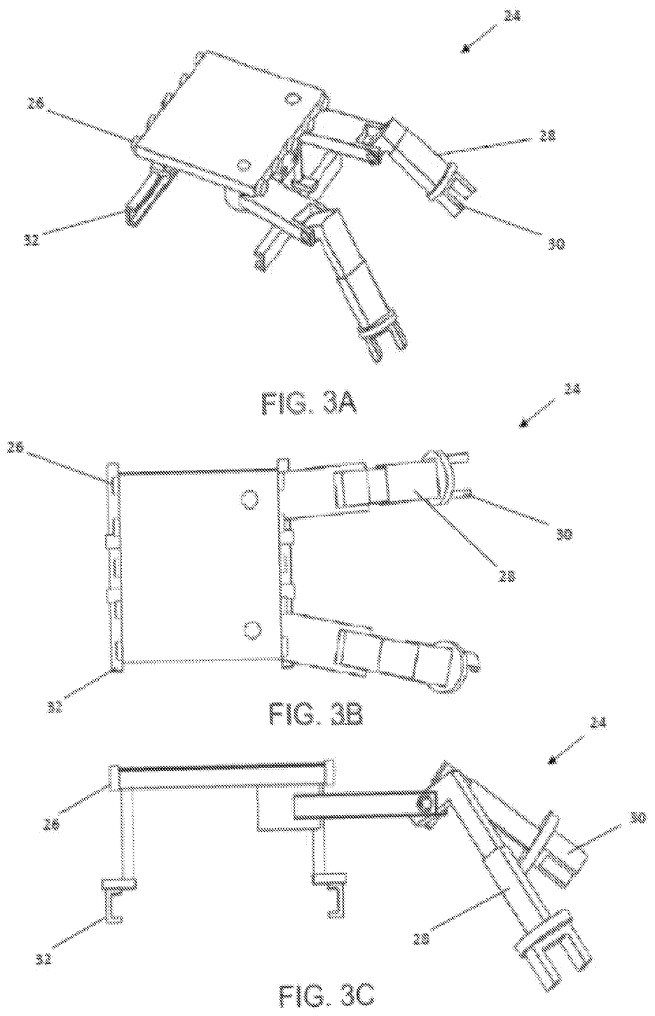

FIGS. 3A-3C illustrate motorized robotic modules 24 that ride and travel on the extension rails 20 from one room to the other (after corresponding gantry cars have been aligned with extension rails extended). The robotic module 24 are equipped with inline wheels 26 that ride on the extension rails 20, as well as one or more manipulating arms 28 with terminations 30 designed to accommodate various grabbing attachments and tools. The manipulating arms 28 typically have a shoulder, elbow, and wrist to provide a wide range of motion with interchangeable hands, grippers, and tools. The robotic module 24 folds to minimize volume and is capable of being remotely controlled by human or computer based operators. In specific embodiments the robotic module 24 may be configured with an auxiliary set of rails 32 to support a second robotic module or platform below the first robotic module (extendable to other platforms or modules). Robotic modules 24 may additionally contain; one or more cameras, vacuum cleaner systems, dishwashing systems, floor washing systems, carpet cleaning systems, toilet cleaning systems, dusting systems, painting systems, maintenance systems, construction systems, tool kits, baskets, trays, bins, etc. Embodiments of the robotic modules 24 configured with a vacuum cleaning system may include related tools and equipment illustratively including filters, collection bins, one or more retractable hoses, attachments (nozzles, motorized brushes, etc.). Embodiments of the robotic modules 24 configured with dish cleaning capabilities may include features such as a water collector from faucet (supply), a water heater, a water pressurizer and sensor, an air compressor, a retractable hose (one or more), tools (brushes, nozzles, etc.), and a wet vacuum. Embodiments of the robotic modules 24 configured with wet cleaning system (for floors, bathrooms, carpets, etc.) may include a water collector from faucet (supply), a water heater, a water pressurizer and sensor, an air compressor, a retractable hose (one or more), tools (brushes, nozzles, etc.), and a wet vacuum. Embodiments of the robotic modules 24 configured with a painting system may include a paint supply, airbrush, airless delivery, paint rollers, and paint related tools. Embodiments of the robotic modules 24 configured with a maintenance system may include hand tools, as well as, motorized tools that illustratively include drills sanders, and caulking guns. The robotic modules 24 may include a collection/delivery bin or tray that illustratively includes uses for dishes, toys, laundry, garbage, recycling, etc.

Construction applications of the robotic modules 24 may include floor laying and tile installation grouting, concrete laying, etc.

The aforementioned modular embodiments may transfer from room to room by moving along the rails (to be described in greater detail below). Modules 24 may also move from room to room by moving along the rail sets located on other modules 24. Multiple modules 24 may hang from each other under the lower platform portion of the gantry car 14, and module 24 may be transported from room to room by association with the module directly supported by the gantry car.

Translation drive options to move the gantry cars 14 and robotic modules 24 include the use of cables, linear motors, rack and pinion, screw drives, and drive wheels

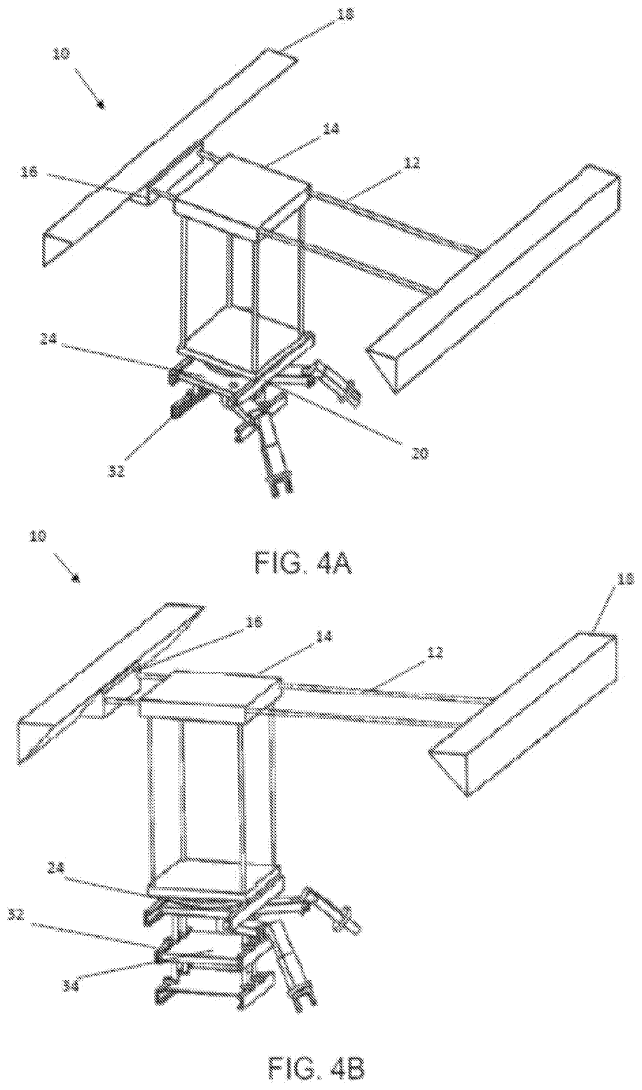

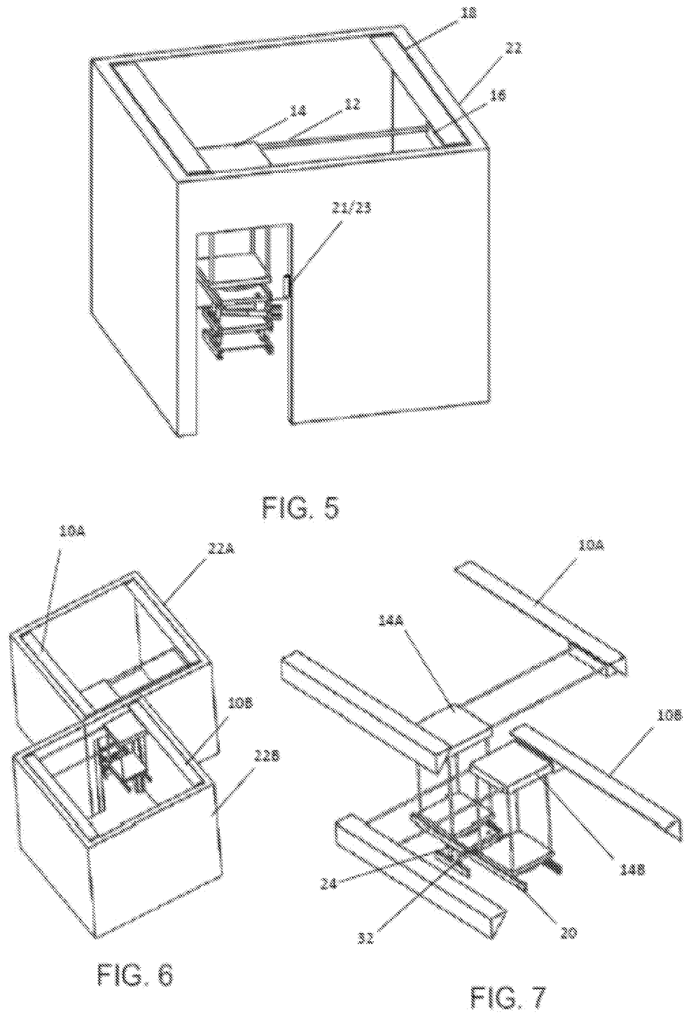

FIG. 4A illustrates a perspective view of the wire supported X-Y-Z gantry system 10 of FIG. 1 outfitted with a motorized robotic module 24 where like numerals have the meaning ascribed to thereto with respect to the aforementioned drawings. FIG. 4B illustrates a perspective view of the wire supported X-Y-Z gantry system 10 outfitted with a motorized robotic module 24 with additional platforms 34 suspended from the motorized robotic module 24 from the auxiliary rails 32 where like numerals have the meaning ascribed to thereto with respect to the aforementioned drawings. FIG. 5 illustrates the wire supported X-Y-Z gantry system 10 configured with the additional platforms 34 of FIG. 4B mounted in a room or a walled enclosure 22 where like numerals have the meaning ascribed to thereto with respect to the aforementioned drawings.

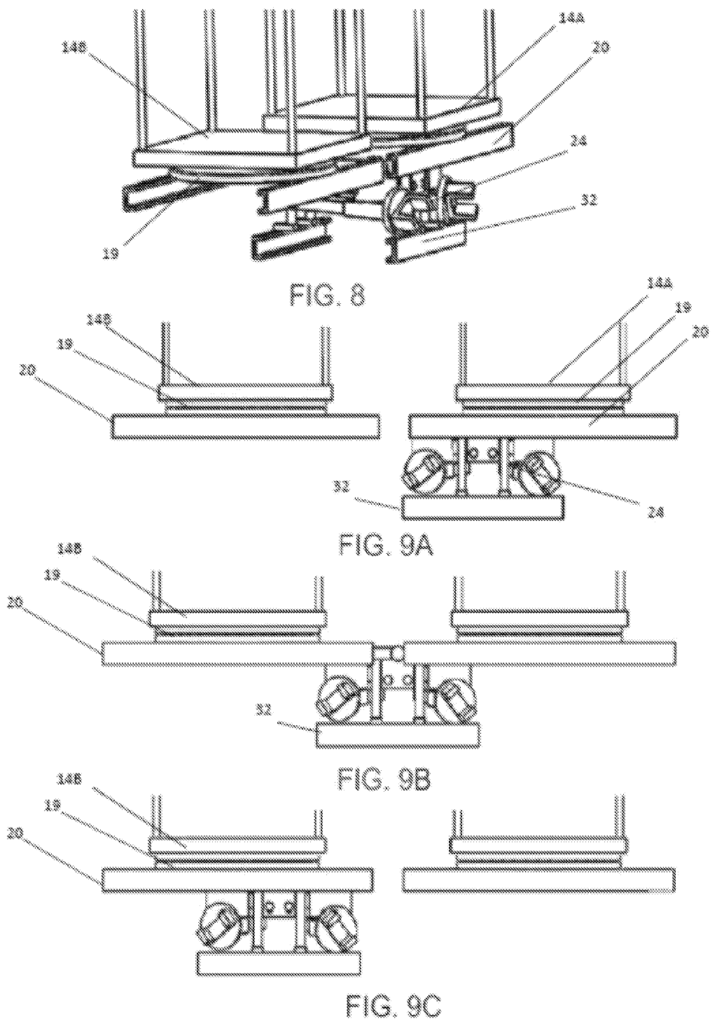

FIG. 6 illustrates adjoining rooms or enclosures (22A, 22B) with separate X-Y-Z gantry systems (10A, 10B) where like numerals have the meaning ascribed to thereto with respect to the aforementioned drawings. FIG. 7 illustrates the transfer of motorized robotic module 24 between the adjoined rooms (22A, 22B) of FIG. 6 with the alignment of the extension rails 20 where like numerals have the meaning ascribed to thereto with respect to the aforementioned drawings. FIG. 8 is a perspective view of the gantry cars (14A, 14B) and the alignment of the extension rails 20 for transfer of the motorized robotic module 24 where like numerals have the meaning ascribed to thereto with respect to the aforementioned drawings. FIGS. 9A-9C illustrate the progress of the transferring of the motorized robotic module 24 between wire supported X-Y-Z gantry systems (10A, 10B) of adjoining rooms or enclosures (22A, 22B) via the alignment of the extension rails 20 of gantry cars (14A, 14B) where like numerals have the meaning ascribed to thereto with respect to the aforementioned drawings. It is noted that in a specific inventive embodiment, instead of the rails 20 extending to enable robotic modules 24 to pass from one gantry system to the next, the robotic modules 24 could be capable of bridging the gap themselves.

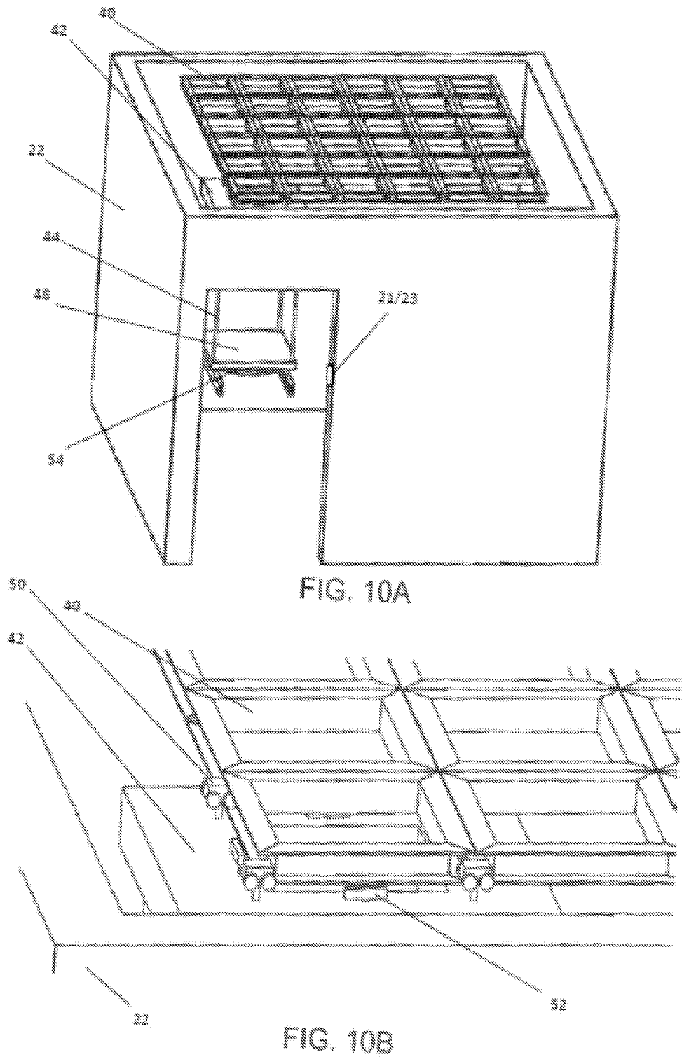

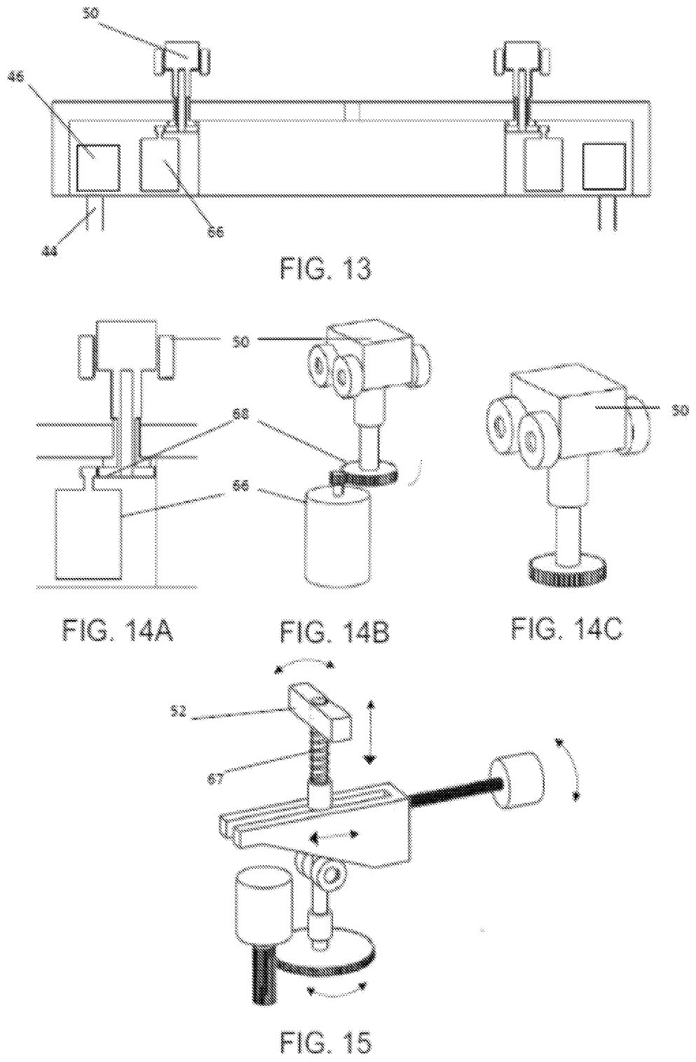

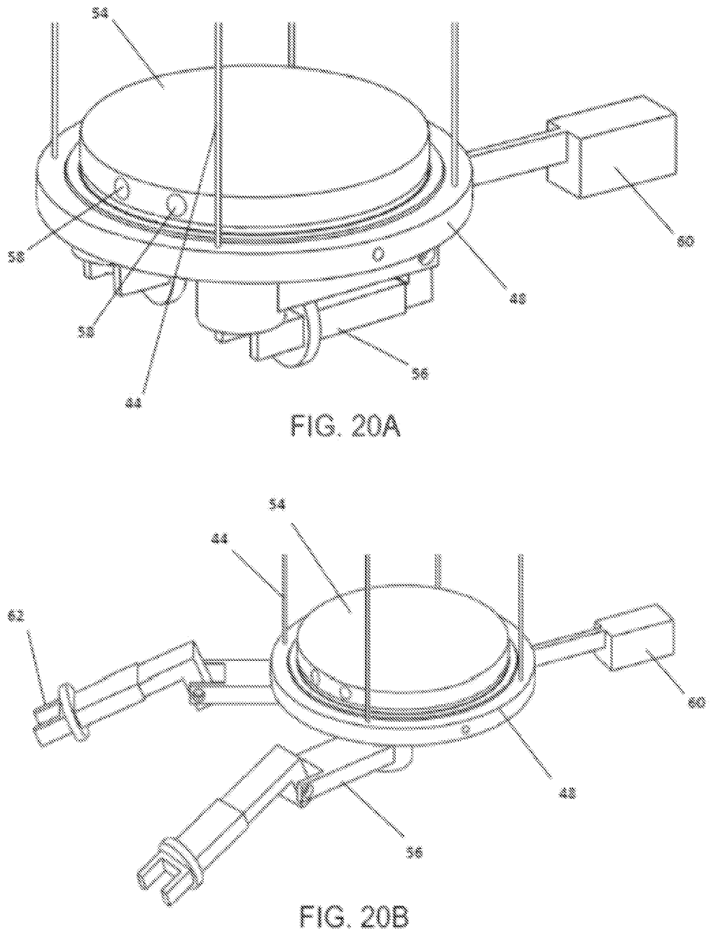

FIGS. 10A, 10B, 11A, 11B, and 12 illustrate a ceiling mounted X-Y rail system 40 in a room or enclosure 22 is provided which support a motorized gantry 42 which translates on the X-Y rails 40 where like numerals have the meaning ascribed to thereto with respect to the aforementioned drawings. The X-Y rails 40 supply electrical power to gantry 42. Gantry 42 contains three or more motorized lifts 46 (see FIG. 13) that drive cables 44 which support, raise, lower and tilt a platform B 48. It is appreciated that differential winch operation causes a suspended platform to tilt, an orientation that can promote loading and unloading thereof. Gantry 42 also contains four drive wheel modules 50 and four lifts 52 which work in concert to move gantry 42 in X-Y directions on the X-Y rails 40. Gantry 42 supplies electrical power to platform B 48. Platform B 48 supports a motorized rotating platform C 54. Platform B 48 supplies electrical power to platform C 54. Platform C 54 supports one or more multiple degree of freedom (DOF) robotic arms 56 (see FIGS. 17B and 20B), one or more cameras 58, and may support one or more motorized counter-balance systems 60. Platform C 54 supplies electrical power to the arms 56, cameras 58, and counter-balance system 60. Each arm 56 contains an interface 62 at the distal end for interchangeable motorized tools (graspers, hands, drills, suction cups, etc.). Each arm supplies electrical power to the various tools. The arms, cameras and/or counter-balances may be attachable and detachable (automatically or manually) from a platform. A docking system between the arms, cameras and/or counter-balances; and platform enables manual or automatic mechanical attachment, and electrical connection. In a preferred embodiment, standard electrical/mechanical interfaces therebetween are provided so that various components from various manufacturers can be installed and function in the present invention.

In order to reduce the weight and volume of platform C 54, the counter-balance system(s) 60 may have various sized detachable weights which may be stored in a location separate from the rail system 40 or other platforms. Different weights may be used for different tasks. The weights have a common interface to the counter-balance system 60 for automatic change.

The cameras 58 may be mounted on motorized pan-tilt mechanisms with zoom capability. The arms 56 fold up for compact storage and can be tele-operated. Any of the platforms A, B, or C may contain batteries. The volume above and between the X-Y Rails may be used to contain other components: storage modules 69, lights, cameras, speakers, audio and video components, displays, smoke detectors, sensors, electronic equipment, dishwashers, vacuum cleaners, air purifying systems, air heating and cooling systems, charging stations, or a combination thereof.

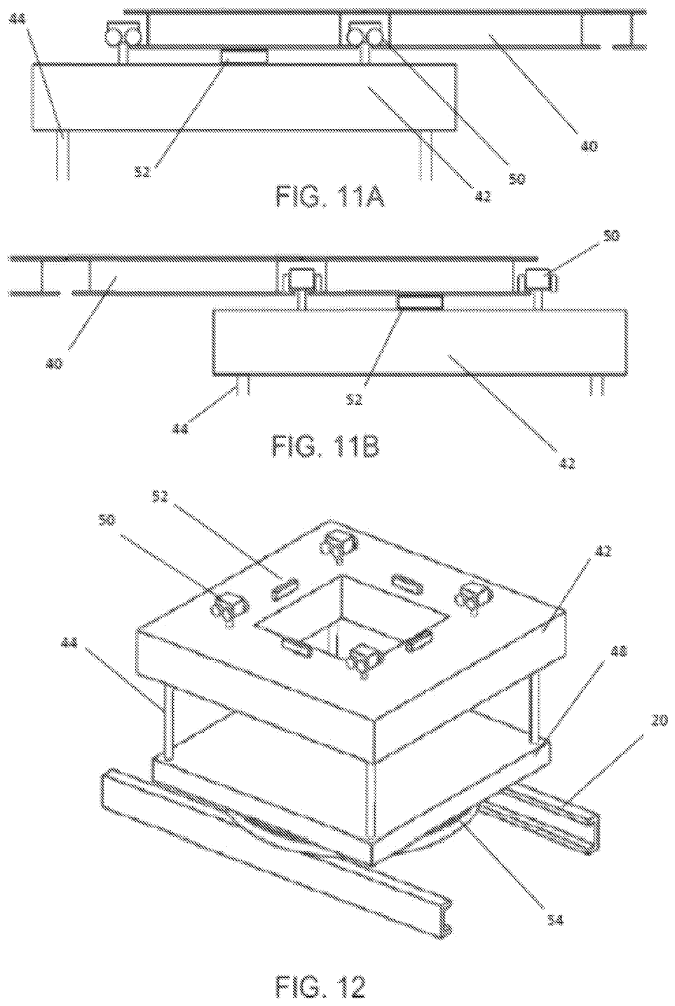

FIG. 11A is a side view of the rail system positioned as shown in FIG. 10B. With a linear translation in the plane of the page by one rail and a right angle rotation of the wheel modules 50, the gantry 42 is positioned to translate orthogonal to the plane of the page in FIG. 11B. The gantry 42 is shown for clarity detached from the rail grid 40 in FIG. 12.

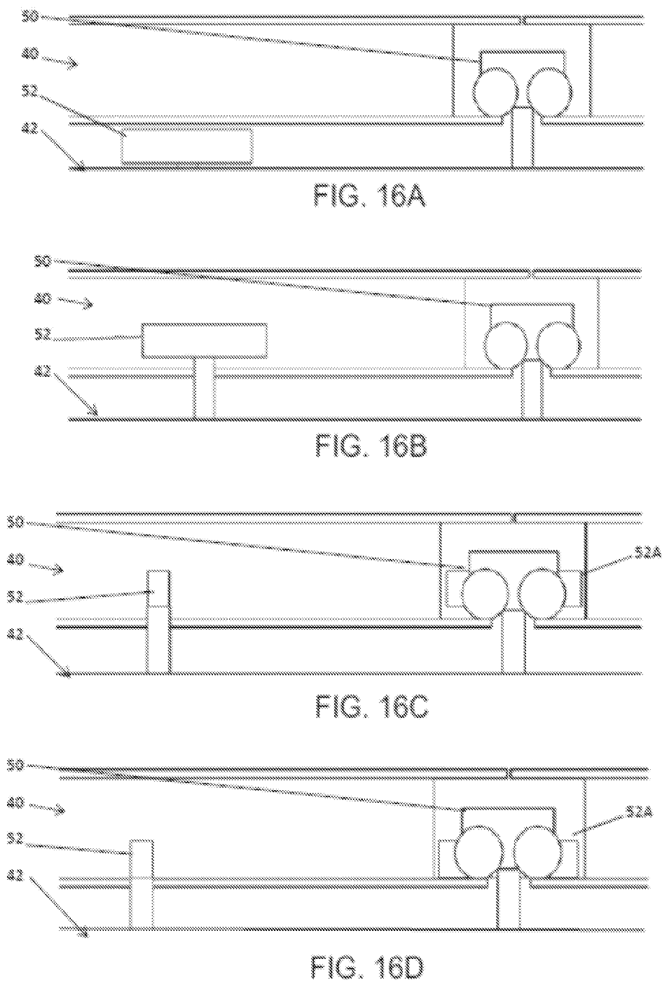

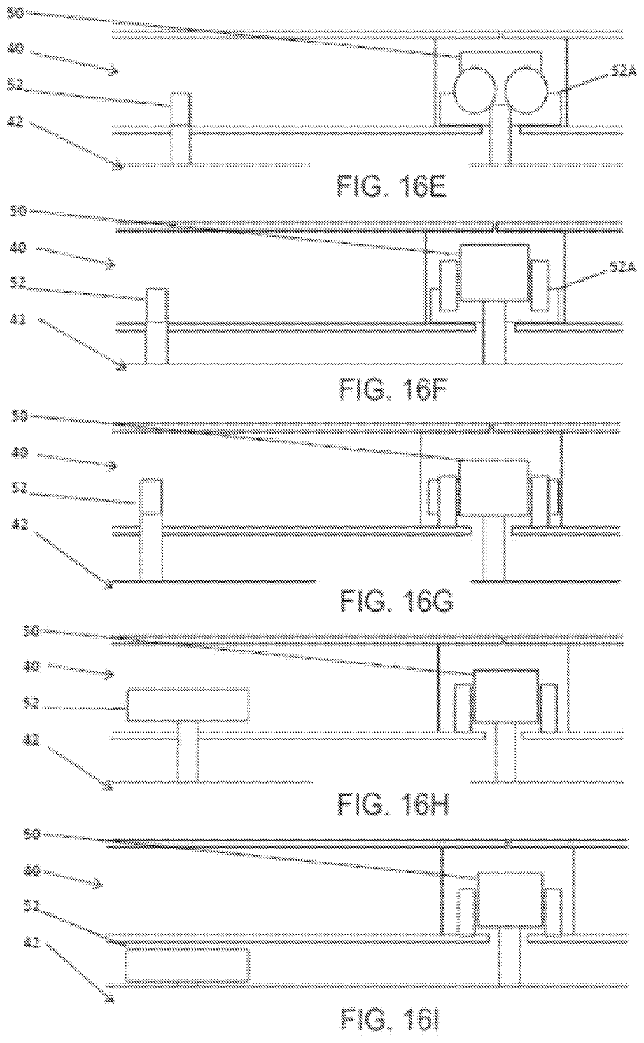

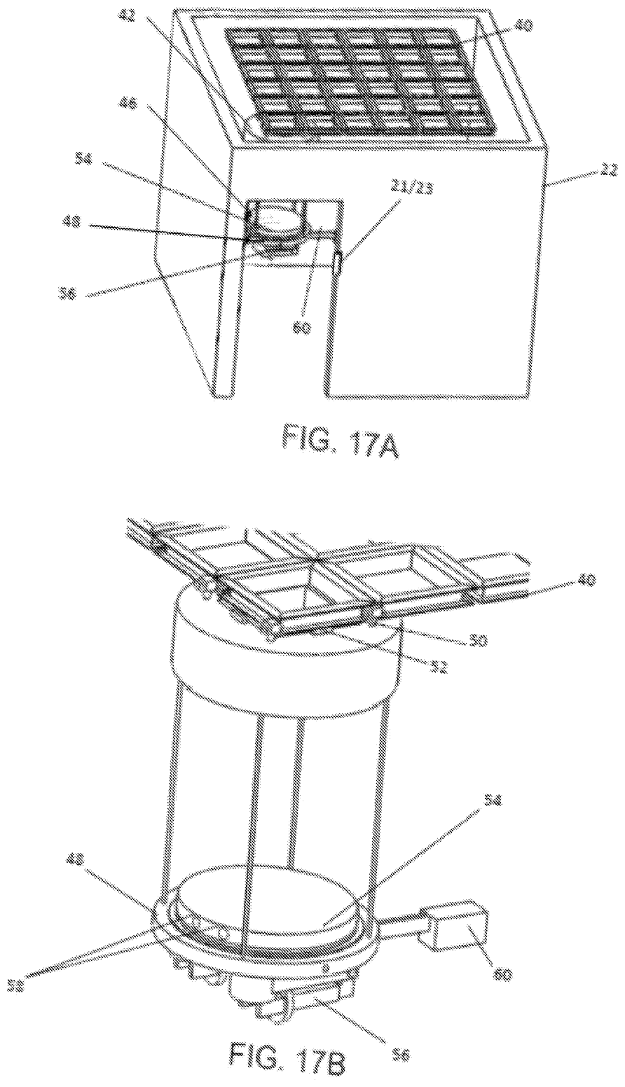

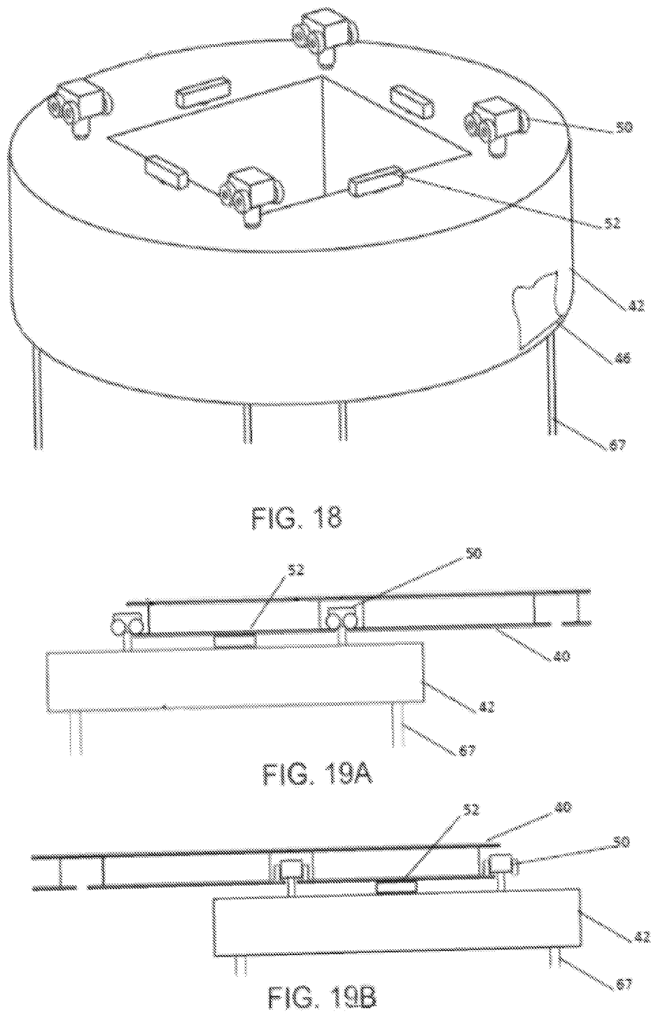

FIGS. 13, 14A-14C, 15, and 16A-16I illustrate the lifting and drive mechanisms for translating the four drive wheel modules 50, and lifting-rotating the modules 50 to affect navigation throughout the X-Y rails 40 where like numerals have the meaning ascribed to thereto with respect to the aforementioned drawings. The four drive wheel modules 50 are powered by an electric motor 66 providing drive power through a gear train 68. The electric motors are energized through line power, battery supplied electricity, or a renewable energy source in electrical communication therewith. The lift shown generally at 46 has rotational, lateral translational and vertical translational degrees of freedom imparted by gearing shown generally at 67 including worm gears, screw gears. It is appreciated that mechanical couplings to impart such motions beyond these are well known to the art and illustratively include stepper motors, hydraulics, pneumatics, and a combination thereof. The sequence of steps associated with the change of direction of a gantry 42 with respect to X-Y rails 40 are shown in FIGS. 16A-16I. From the position of the wheel module 50 and lift 52 in FIG. 16A, the lift 52 is elevated into the rail 40 (FIG. 16B) and rotated 90 degrees, while a second lift 52A position behind the wheel module 50 is rotated out of phase with lift 52 (FIG. 16C). The lifts 52 and 52A are then lowered along with the platform 42 (FIG. 16D), the platform 42 is then raised to disengage the wheel module 50 from contact with the rail 40 (FIG. 16E) and the wheel module 50 is rotated 90 degrees (FIG. 16F) and lowered to re-engage with the rail 40 (FIG. 16G), lifts 52 and 52A are rotated back to original positions as they are no longer be load bearing (FIG. 16H), and the platform is returned to the original position of FIG. 16A save for a 90 degree rotation of the wheel module 50. It should be appreciated that only one wheel module 50 is shown for visual clarity and that all four such modules and interspersed lifts are operated in concert to affect a direction change for the gantry 42 relative to the X-Y rails 40.

Automating the storing and retrieving of items in a building requires a location to store the items and a system to automatically retrieve and replace the items. Most buildings do not have storage space that is conveniently located for access by automated systems (robots, automation, etc.). The storage spaces that are available (drawers, cupboards, cabinets, closets, shelves, etc.) are usually a cluttered mess and not organized for automation. If people have access to these storage areas, they may become unusable for automatic retrieval because the items will be moved around without the knowledge of the automated system.

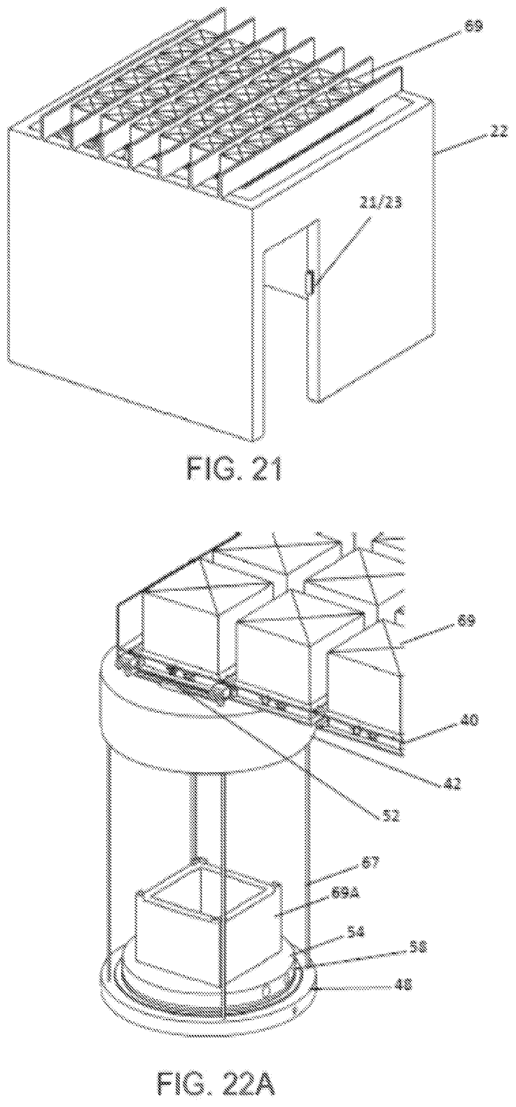

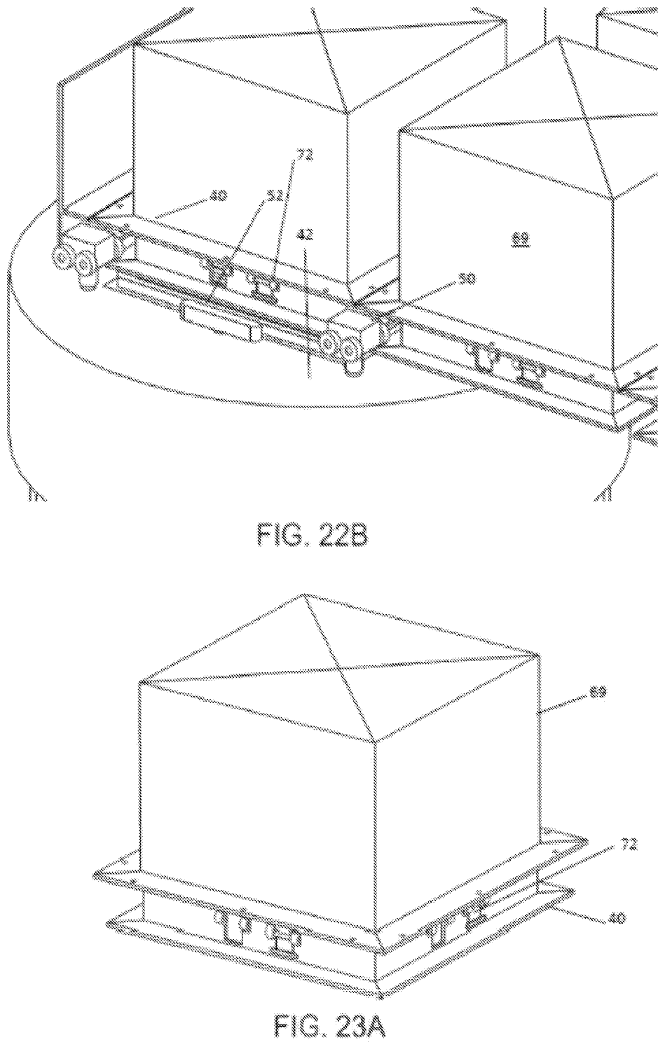

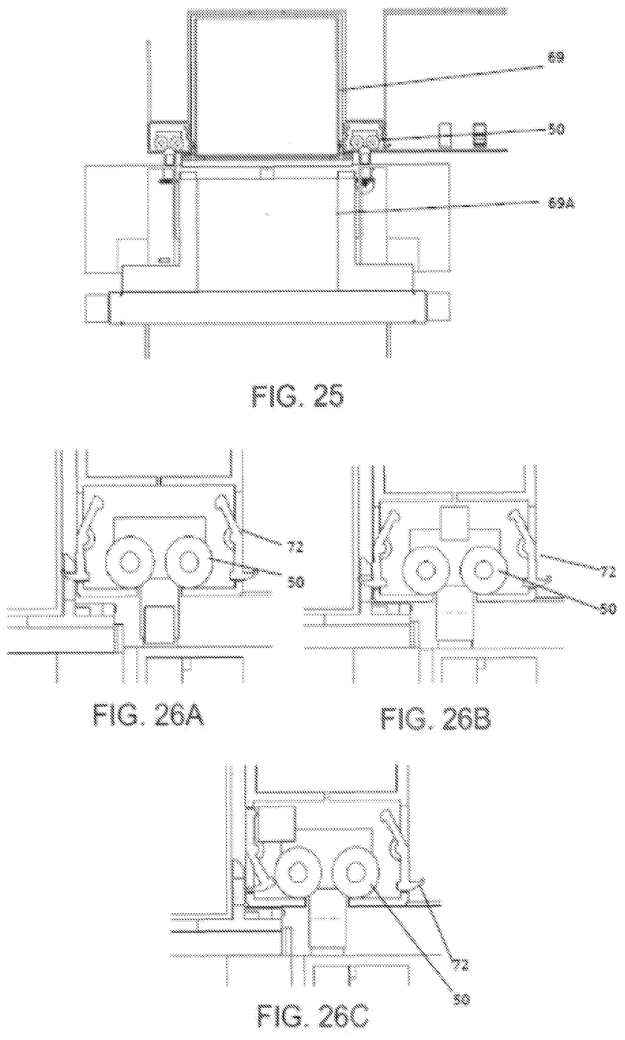

FIGS. 21, 22A, 22B, 23A, 23B, 23C, 23D, 23E, 24A, 24B, 25, 26A, 26B, and 26C illustrate another embodiment of the present invention with storage modules present above the X-Y rails 40 where like numerals have the meaning ascribed to thereto with respect to the aforementioned drawings. An array of storage modules 69 are provided that are ceiling mounted. This is depicted with interspersed ceiling joists in FIG. 21. This is accomplished by mounted to, for example, sheet-rock, ceiling joists, or drop ceiling systems) X-Y rails 40 in each room 22 which support a motorized gantry 42 which can translate orthogonally on the X-Y rails 40. The X-Y rails 40 supply electrical power to gantry 42. In some inventive embodiments, at least two of the array of storage modules 69 are stacked on one another forming a stack 76. This is depicted in in FIGS. 31A-35.

A gantry 42 contains three or more (4×) motor driven winches 46 that extend and retract cables 44 which support, raise, lower and tilt a platform B 48. Gantry also contains drive wheel modules (4×) 50 and lifts (4×) 52 which work in concert to move carriage A in orthogonal directions on the X-Y rails. Gantry 42 supplies electrical power to platform B 48.

In a specific inventive embodiment, gantry 42 contains motorized winches 46 that extend and retract cables 44 which support, raise, lower, tilt and now rotate platform B 48. Gantry 42 supplies electrical power to platform B 48 which in turn supplies power to platform 54.

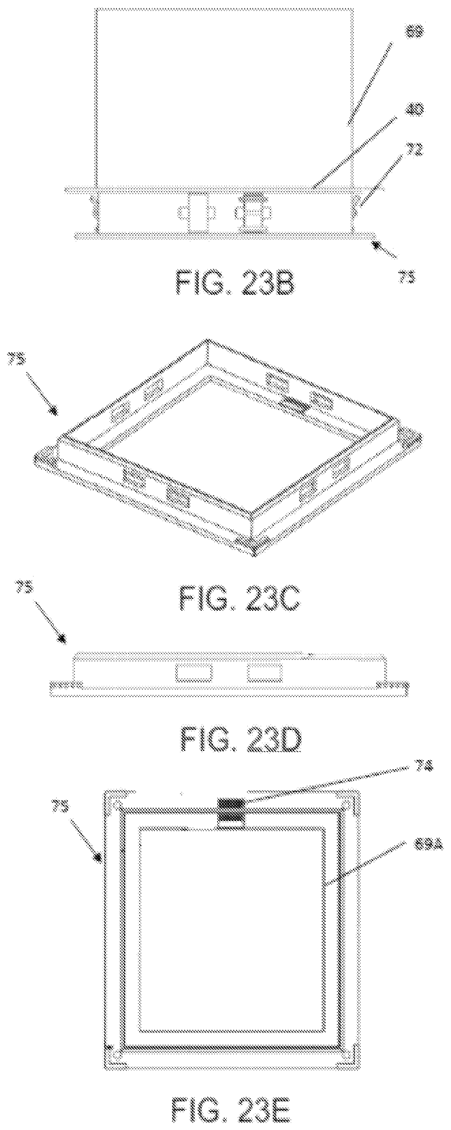

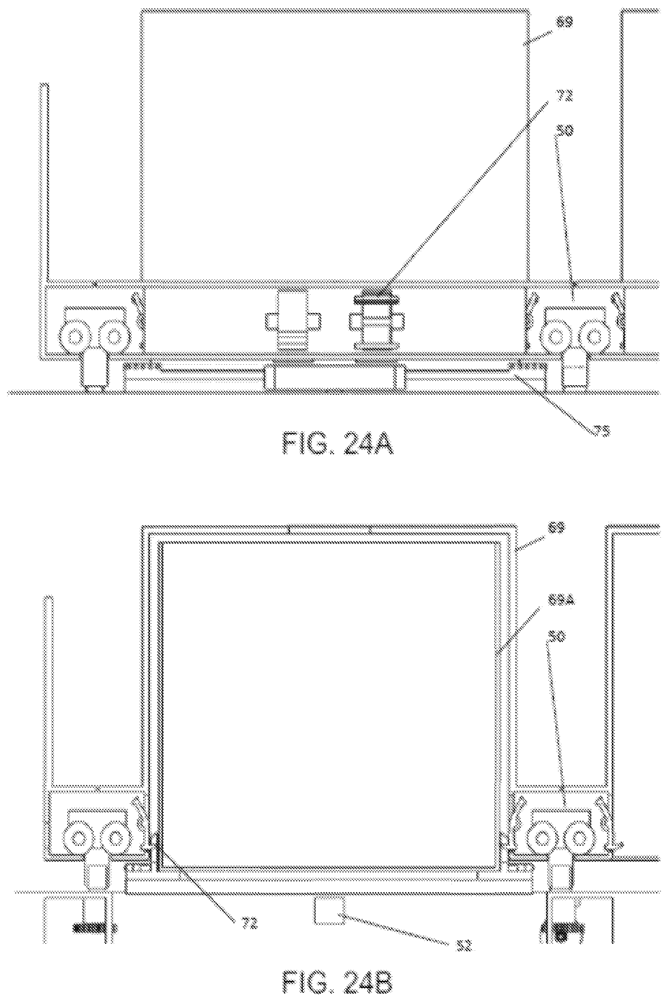

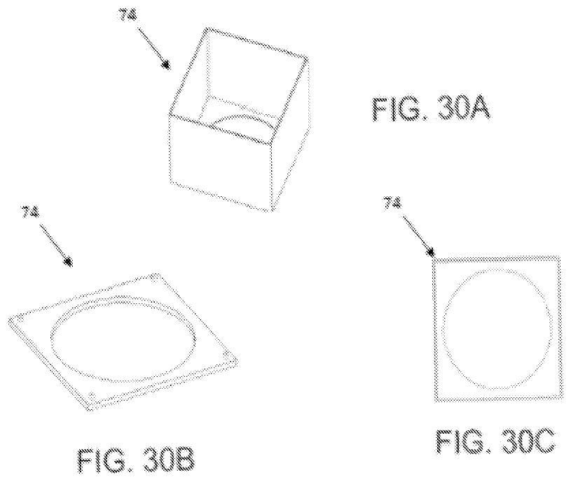

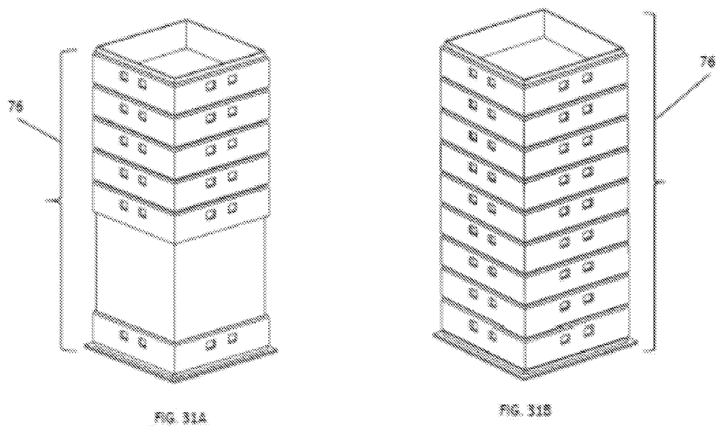

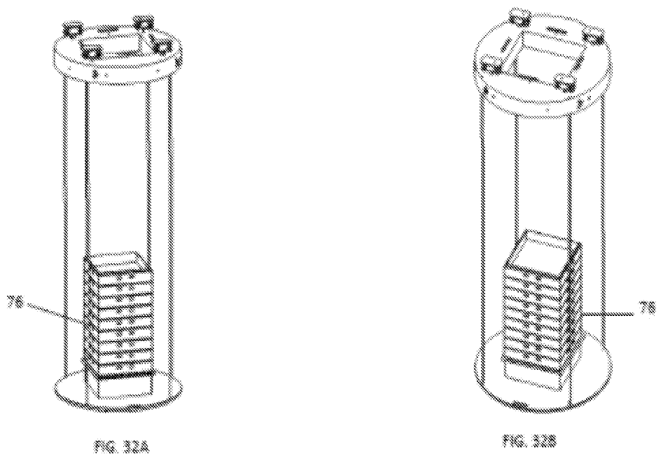

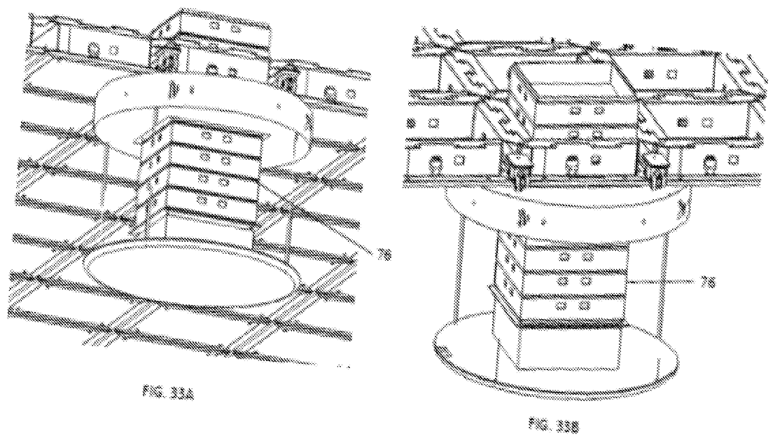

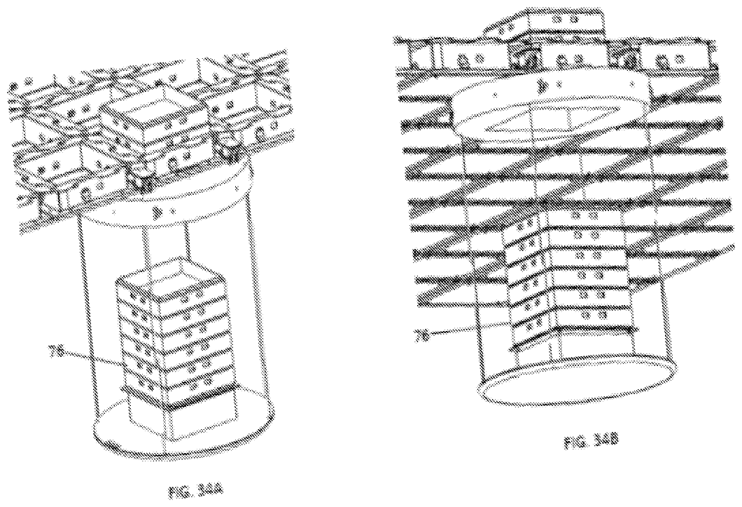

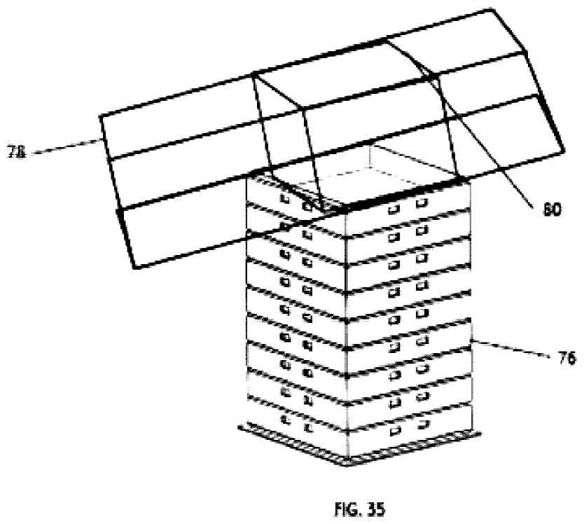

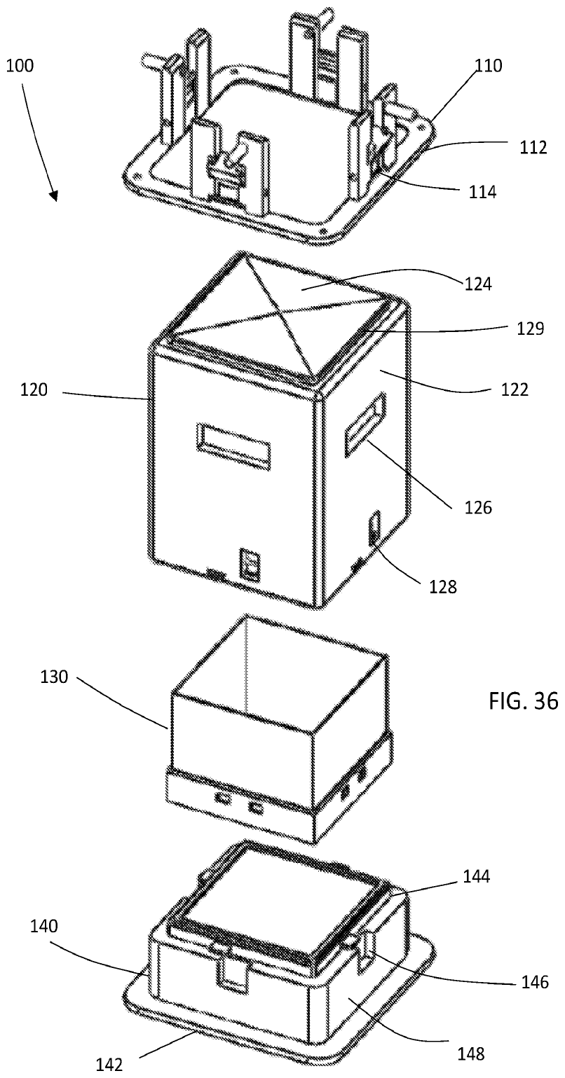

A latch 72 provides selective access to the storage modules 69. A mechanical/electrical interface 74 is provided between the storage module 69 and a cosmetic panel 75, as best illustrated in FIGS. 23A-23E. A cosmetic panel 75 and a bottom surface of a storage module 69 or lower portion 69A thereof are amenable to surface treatment such as painting or texturing for aesthetic reasons to create a ceiling having a desired appearance. Cosmetic panels 75 can be acoustic tiles, 3-D sculptures, video displays, foam, glass, wood, metal, plastic, lights, IR heaters, or a combination thereof. FIGS. 30A-30C illustrate a lower portion 69A with a circular central door omitted for visual clarity or a cosmetic panel 75 with such an opening.

As a result, the volume above, between and below the X-Y rails 40, as well as the space between the ceiling joists is used to store modules 69 in a controlled storage location for automated retrieval and replacement, said modules illustrative have within them storage units, storage bins, storage shelves, tables, robots, games, displays, refrigerators, freezers, ovens, microwaves, humidors, fire extinguishers, wine racks, lights, cameras, speakers, audio and video components, displays, smoke detectors/alarms, sensors, electronic equipment, dishwashers, vacuum cleaners, air purifying systems, air heating and cooling systems, charging stations, dispensing units, or a combination thereof. It is appreciated that the rails can form a variety of shapes and sizes to accommodate storage modules 69 that are of a variety of shapes and sizes such as cuboidal or hemispherical volumes. It is further appreciated that the rails can also accommodate a variety of configurations of the storage modules 69, illustratively including a stack of storage modules 76. The storage modules 69 can be accessed robotically via the robotic arms 56, the platform B 48 or manually. A storage module 69 as depicted has an inserted and inverted inner portion 69A with a top opening that is complementary to module 69 to form a closed unit. It is appreciated that the inner portion 69A is a removable floor, a tray, or having sidewalls that extend to an extreme of contacting an upper surface of the module 69. It is appreciated that the entire contents of a module 69 are delivered to a user or an article is accessed, the storage module 69 closed, and only the desired article delivered. A pencil box and refrigerated items being exemplary of the former and the latter, respectively. It is further appreciated that in some inventive embodiments, a particular storage module 69 that is part of a stack of storage modules 76 is selectively retrieved and delivered to a user, or an article accessed therefrom is delivered to a user.

A controller 21 provides a human user interface 23 that is a display, touch screen, auditory, or a joystick receives user input as to the desired articles from storage, the location of delivery and the scheduling of delivery. The controller 21 has access to a database inventory of articles stored in the storage modules 69, or to be stored in the modules. The controller then instructs the movement of the gantry 42 to retrieve or store articles and any desired manipulation of the robotic arms 56.

A sequence of latch 72 manipulations to access a storage module 69 or a stack of storage modules 76 and secure the same in the context of the present invention are illustrated in FIGS. 24A, 24B, 25, 26A, 26B, 26C, 33A, and 33B. The various latch positions and access to the volume of a storage module 69 or stack of storage modules 76 are shown.

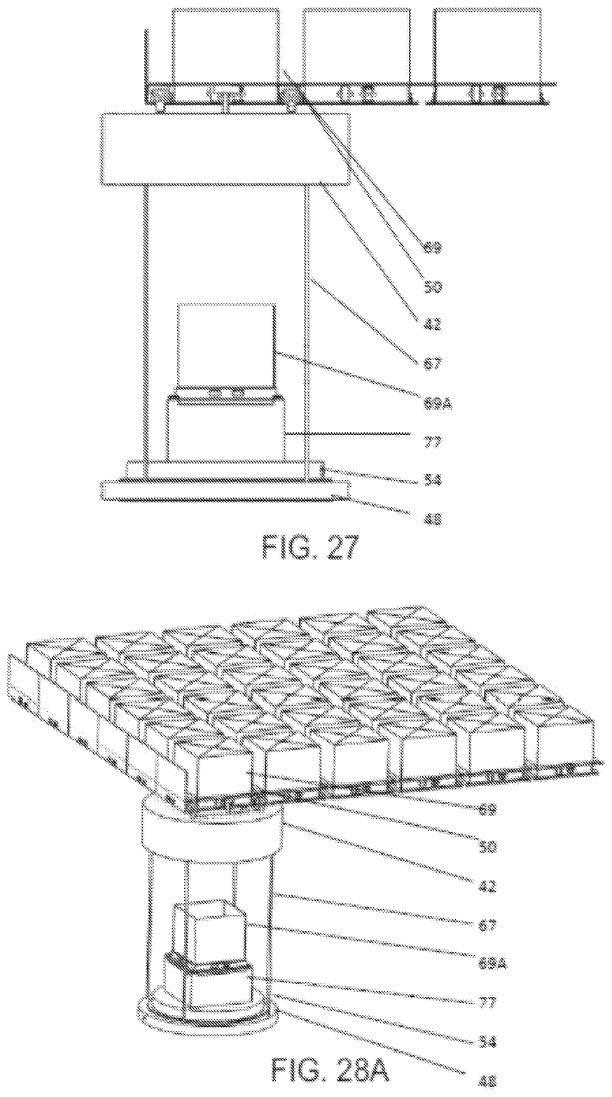

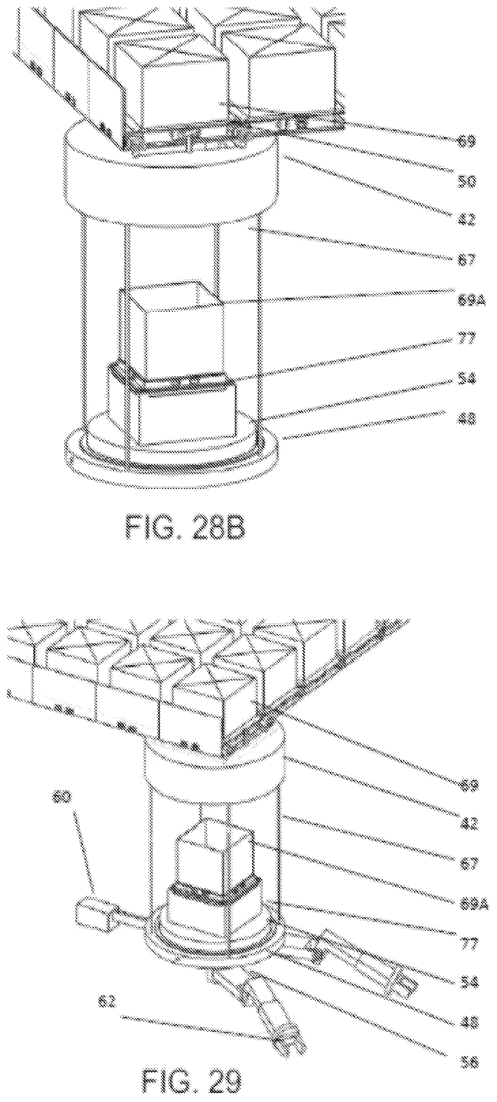

FIGS. 27, 28A, 28B, and 29 illustrate an embodiment of the present invention in which a module 77 is present on platform 48. FIGS. 32A-35 illustrate an embodiment of the present invention in which a stack of storage modules 76 is present on platform 48. A door/opening in the storage portion 69A and/or cosmetic panel 75 enable a sub-platform to be lowered into contact and optionally electrical communication with module 77. As a result the contents of a given storage module 69 can be manipulated in all three dimensions as defined by the extent of a rail system 40, and accessed manually or robotically. With module 77 containing additionally functionality such as an electric power source to operate an article such as an appliance, a scale to weigh contents of a storage module 69, or other such functionality a variety of manual operations are amenable to automation. By way of example if storage modules are laboratory animal cages, plants or terrariums, the occupants of each module 69 are monitored and supplied by way of an inventive system in an automated way by a local or remote user. In still another example, food stuffs are retrieved from storage, prepared, served, then used plates and utensils are cleaned and removed by an inventive system.

As illustrated in FIG. 35, in some inventive embodiments one storage module 69 of the stack of storage modules is accessible from a roof 78 through a hatch 80 in the roof 78. It is appreciated that an article is deposited into the hatch 80 from the roof 78 and collected to be stored in the storage module 69. Articles deposited into and collected via the hatch 80 illustratively include mail parcels, food, medicine, and the like. It is further appreciated that in some inventive embodiments, an article stored in the storage module 69 is collected via the hatch 80 and transported away from the building by a variety of mechanisms and technologies known in the art, illustratively including by drone. Items that are collected via the hatch 80 and transported away from the building illustratively include garbage, recycling, and outgoing mail parcels.

It is appreciated that a variety of sensors, video displays, speakers and microphones on the X-Y rails, translation platforms, storage platforms, cosmetic panels or a combination thereof can be incorporated. As a result, a tele-presence is created that allows for more complex control and operational feedback. It is also appreciated that any platform or module detailed herein may contain batteries to serve as a main or backup power source for an inventive system, module or stored article.

As shown in FIG. 36, embodiments of the present invention additionally provide a system 100 of delivery vehicle interfaces 110, delivery containers 120, item trays 130, and docking stations 140 to facilitate movement of items from one location to another location while securing such items from theft. Unlike existing systems, the inventive system 100 provides a method of reversing the processes in order to automatically retrieve items back from the location of delivery. According to certain inventive embodiments, the items are delivered by inserting directly into a building or building automation system. According to certain inventive embodiments, the locations include retail locations, businesses, fulfilment or recycling centers for re-filling, recycling, and/or disposal, industrial locations, agricultural locations, government locations, waste disposal locations, homes, garages, carports, barns, greenhouses, etc. According to certain inventive embodiments, a delivery vehicle interface 110 of the inventive system 100 includes attachment points 112 for attaching the interface 110 to a delivery vehicle (not shown) and delivery container latches 114 for retaining delivery containers 120 during transport. According to certain inventive embodiments, the delivery vehicle interfaces 110 facilitate bottom and/or top loading and include optional actuators to release item tray latches. According to certain inventive embodiments, a delivery container 120 of the inventive system 100 is an enclosure 122 with an open bottom and sloped “horizontal” 124 surfaces to facilitate water runoff. The containers also include handles 126 for human or robotic grasping, latches 128 to retain item trays 130, compliant latch covers for environmental isolation, and interlocking features 129 for stacking multiple containers. According to certain inventive embodiments, an item tray 130 of the inventive system are formed having standard sizes so that they trays are interchangeable. The shape and latching features of the item trays 130 are detailed in U.S. Pat. No. 10,780,576, which is hereby incorporated by reference in its entirety. According to certain inventive embodiments, a docking station 140 of the inventive system 100 includes mounting features 142 to secure to the ground, buildings, and/or vehicles. The docking station 140 also includes a locating interface 144 for a container 120. Releasable latches 146 secure the containers 120 to the docking station 140 and a pedestal 148 lifts the item trays 130 off the latches 146 to facilitate unlatching and a secondary pedestal enables the delivery vehicle interface 110 to latch below the bottom of the container 120.

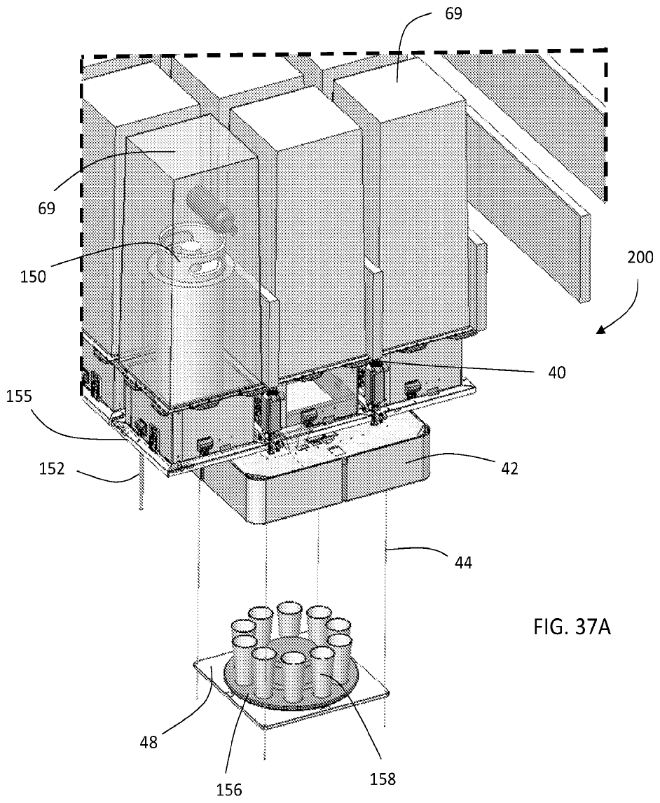

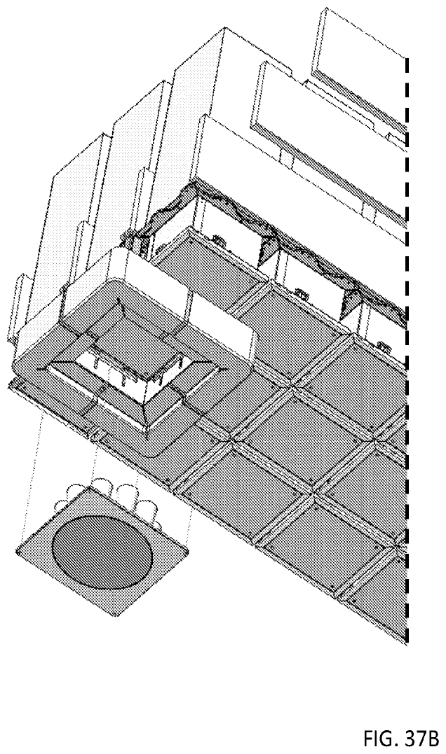

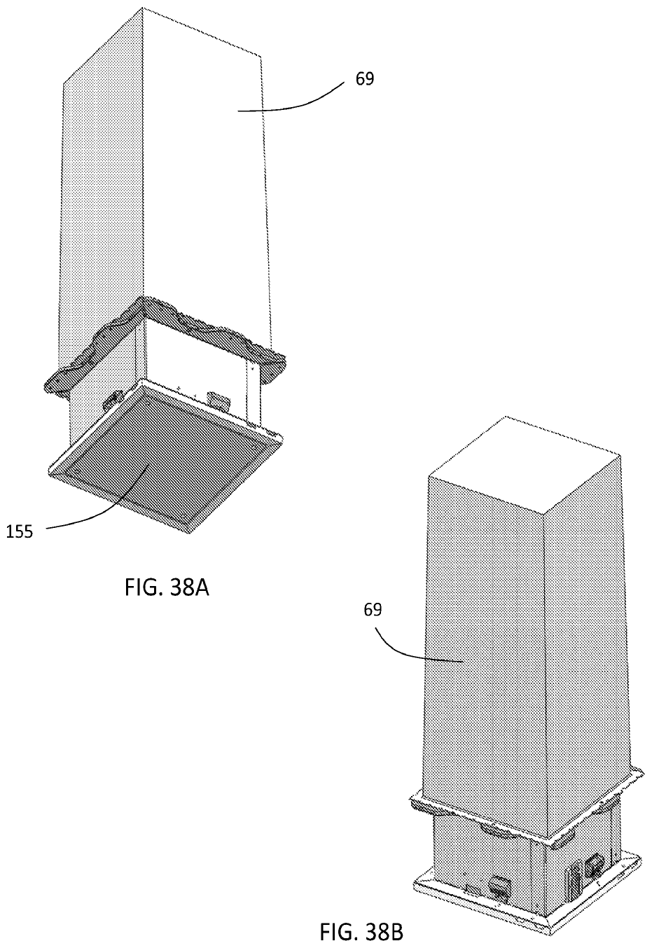

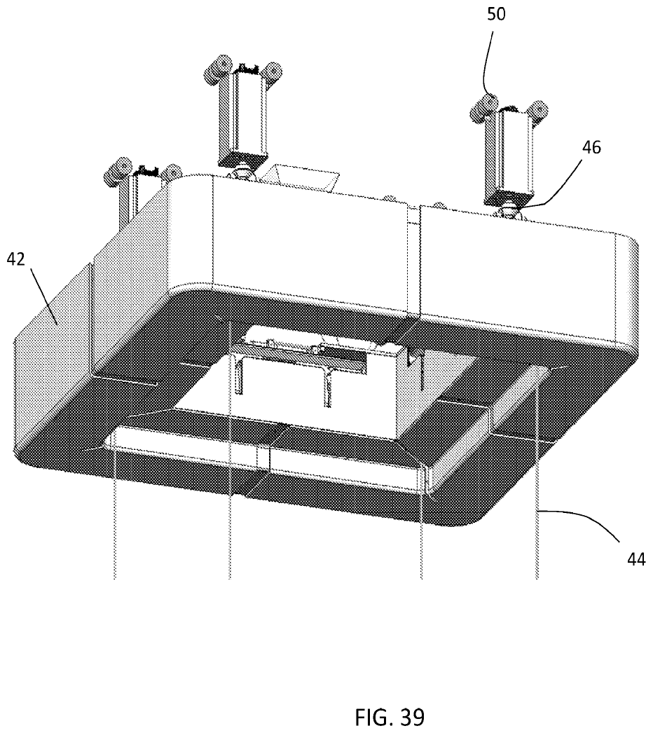

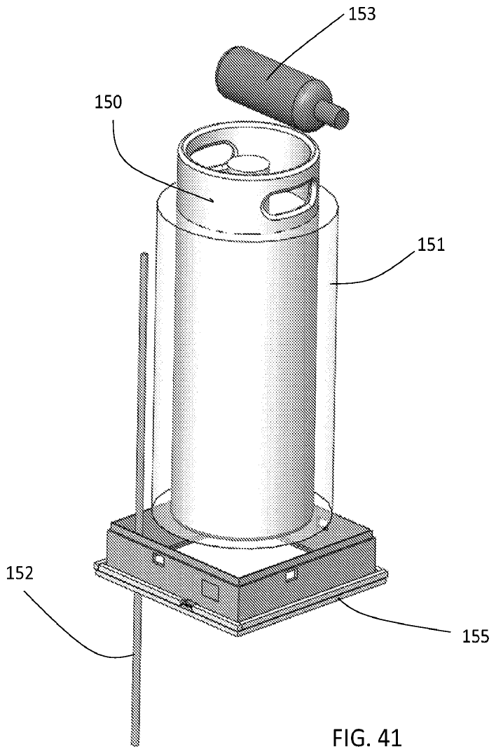

FIGS. 37A-41 illustrate another embodiment of the present invention with storage modules present above the X-Y rails 40 where like numerals have the meaning ascribed to thereto with respect to the aforementioned drawings. An array of storage modules 69 are provided that are ceiling mounted. This is depicted with interspersed ceiling joists in FIGS. 37A and 37B. This is accomplished by mounting to, for example, sheet-rock, ceiling joists, or drop ceiling systems X-Y rails 40 in each room 22 which support a motorized gantry 42 which can translate orthogonally on the X-Y rails 40. The X-Y rails 40 may supply electrical power to gantry 42. According to certain inventive embodiments, the inventive system 200 is configured for use in a bar or restaurant setting, with food and/or beverage storage and/or dispensers 150 provided in the storage modules 69. For example, a beverage storage and dispenser 150 is shown in FIG. 41 as a beer keg 150. In such an embodiment, the storage module 69 additionally houses insulation 151 around the keg 150, a retractable dispending tube 152, a CO2 container, regulator and valve assembly 153 all positioned above the ceiling interface 155.

According to certain inventive embodiments, the keg 150 is for example, a 1 faucet tower keg with a pin lock available online at the Keg Outlet under part number 1Towers20ozPINKit. According to certain inventive embodiments, the keg 150 includes a refrigeration unit 156 that supplies refrigerant to for example a power blanket by North Slope Chillers, available on Amazon.com. The refrigeration unit 156 is configured to keep a keg 150 of draft beer at a temperature of about 38 degrees F.

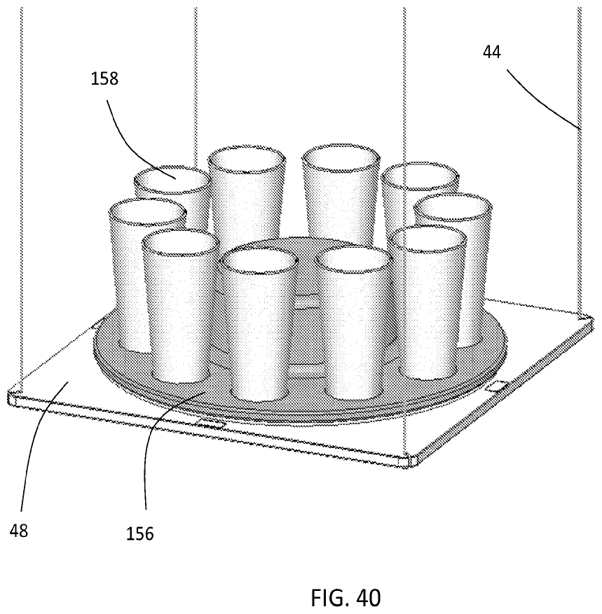

Below the ceiling interface 155, the gantry 42 is generally like that described in FIGS. 21, 22A, 22B, 23A, 23B, 23C, 23D, 23E, 24A, 24B, 25, 26A, 26B, and 26C. That is, the gantry 42 contains three or more (4×) motor driven winches 46 that extend and retract cables 44 which support, raise, lower and tilt a platform B 48. Gantry also contains drive wheel modules (4×) 50 and lifts (4×) 52 (described above) which work in concert to move carriage A in orthogonal directions on the X-Y rails. According to certain inventive embodiments, the platform B 48 includes a rotating tray 156, which according to certain inventive embodiments includes a plurality of recesses 157 for secure placement of a plurality of beverage glasses 158. According to certain inventive embodiments, the rotating tray 156 is 18 inches in diameter and the plurality of beverage glasses 158 includes 10 pint glasses, as shown in FIG. 40. According to such certain inventive embodiments, the winches 46 raise the platform B 48 with the rotating tray 156 and beverage glasses 158 thereon up to be in proximity with the storage module 69 containing a beverage dispenser 150. Then the system uses the retractable dispending tube 152 to fill each beverage glass 158, rotating the tray 156 to position each glass 158 in fluid communication with the retractable dispensing tube 152. Once the glasses 158 or a subset thereof are filled, the winches 46 lower platform B 48 down and the gantry 42 moves along the X-Y rails 40 to deliver the filled beverage glasses 158 to a desired location. The system may also be used to clear glasses 158 or other tableware from a table or bussing station back to a bussing and/or dishwashing station contained in another room or in another storage module 69.

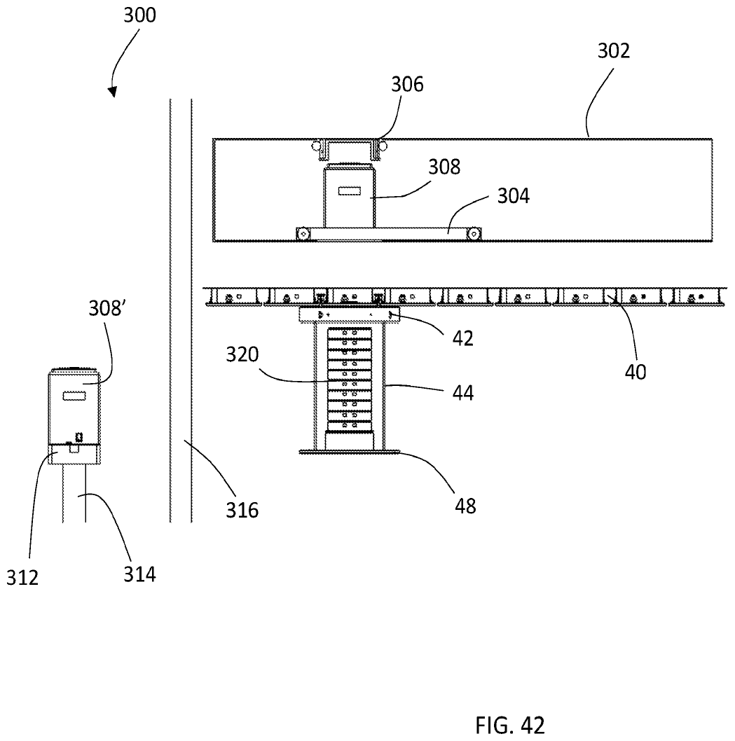

As shown in FIGS. 42-57, the present disclosure additionally provides a system 300 and method for loading and unloading and transferring items between containers of an inventive suspended automation system (embodiments described above). According to certain inventive embodiments, the system 300 and method for such loading, unloading, and transferring facilitates such activities between suspended automation systems that are located in the same building or that are remotely located from one another. As described above, a suspended automation system includes X-Y rails 40, a gantry 42, cables 44, and a platform 48. The loading, unloading, and transfer system 300 additionally includes a transfer tunnel 302 and a swap shuttle 304. According to certain inventive embodiments, the transfer tunnel 302 includes opening 303 in the bottom and/or top thereof, a cable supported tunnel elevator with delivery vehicle interface 306. The swap shuttle 304 includes two positions inside the transfer tunnel 302, outgoing and incoming. The swap shuttle 304 is configured to support and move delivery containers 308, 308′, 308″. The swap shuttle 304 also includes delivery container latch release mechanisms 325/326 to release and latch item trays. According to certain inventive embodiments, the transfer tunnel 302 and the swap shuttle 304 of the system 300 are mounted above the suspended automation system and is configured to extend to and retract from the suspended automation system 300. According to certain inventive embodiments, the transfer system 300 may additionally include, Item Tray(s), Delivery Container(s), Docking Station(s), and Transfer Vehicle(s) with Delivery Vehicle Interface(s) as shown in FIG. 36 and described above as well as elements shown and described in U.S. Pat. No. 10,780,576, which is hereby incorporated by reference in its entirety.

FIG. 42 shows an embodiment of the inventive transfer system 300 in an operation sequence start position, with the system 300 positioned inside and suspended above a suspended automation system and a docking station 312 on an elevator 314 positioned outside the suspended automation system, the inside and the outside being separated by a wall 316.

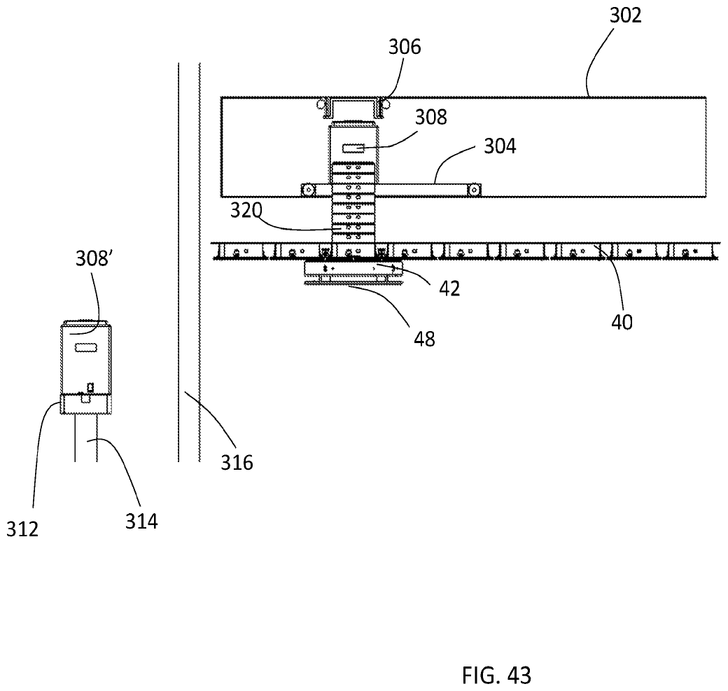

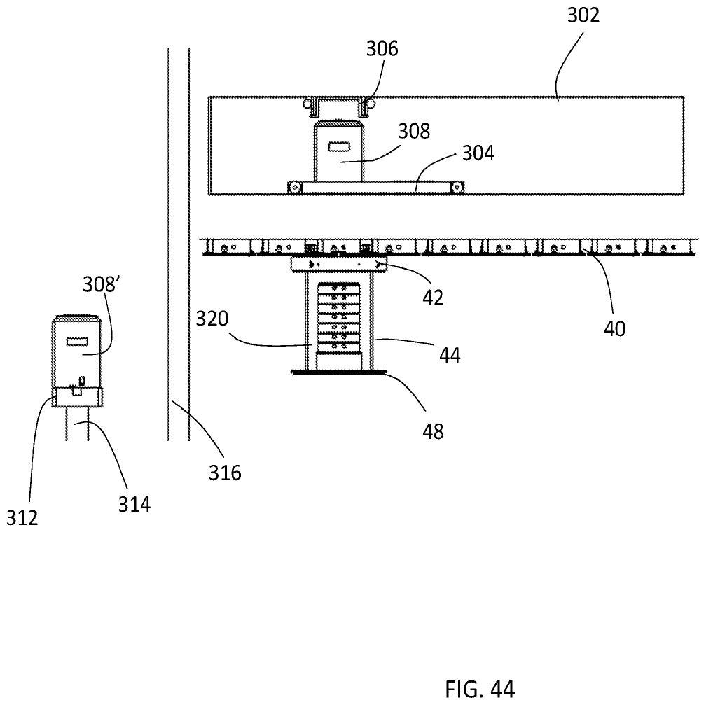

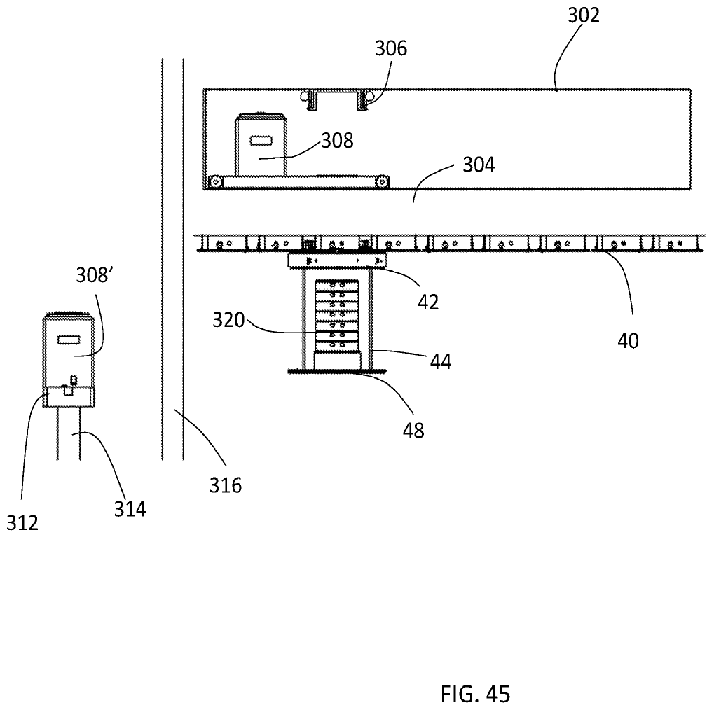

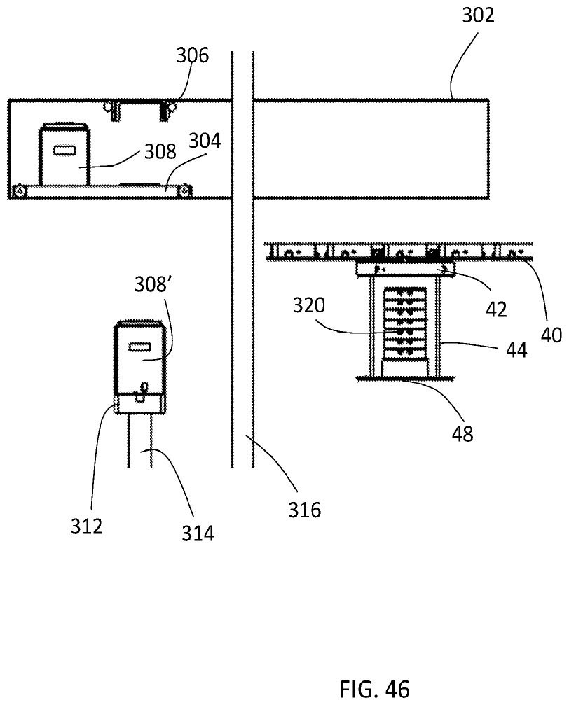

As shown in FIG. 43, a first step of the operation sequence includes raising a stack of trays 320 using the gantry 42 and the cables 44 of the suspended automation system and latching a plurality of trays 320 to an outgoing container 308 positioned on the swap shuttle 304. In FIG. 43, some trays are transferred to the outgoing container 308. As shown in FIG. 44, the next step of the operation is to lower the stack of remaining trays 320 using the gantry 42 and cables 44 of the suspended automation system. As shown, some trays for transfer have been left with the delivery container 308. Next, as shown in FIG. 45, the swap shuttle 304 is shifted with the now loaded delivery container 308 on it. Next, as shown in FIG. 46, the transfer tunnel 302 then extends out of the inside beyond the wall 316, so that the outgoing loaded container 308 on the swap shuttle 304 is positioned outside the suspended automation system while still being inside the transfer tunnel 302.

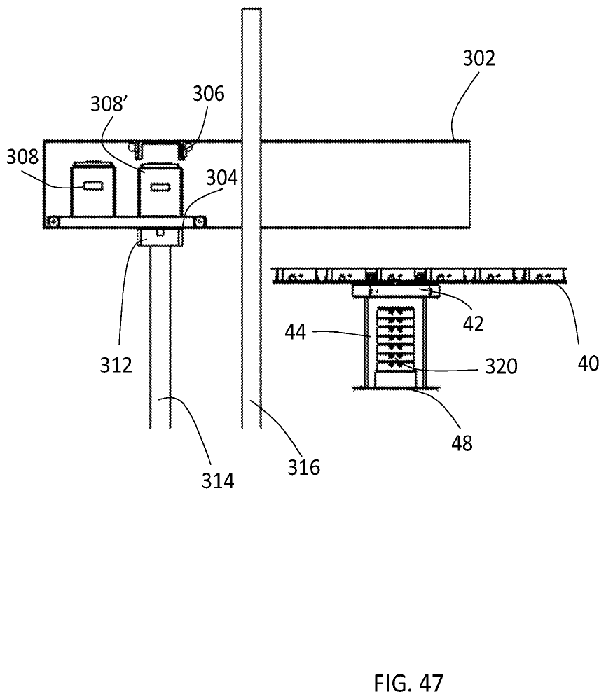

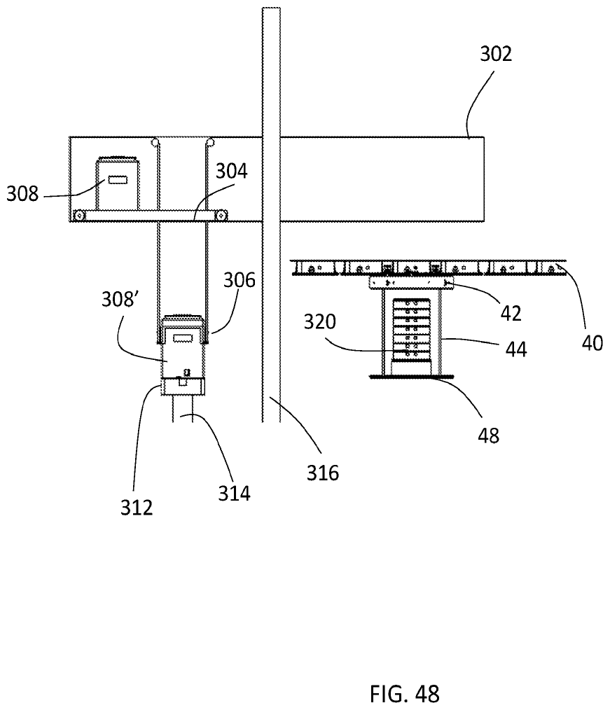

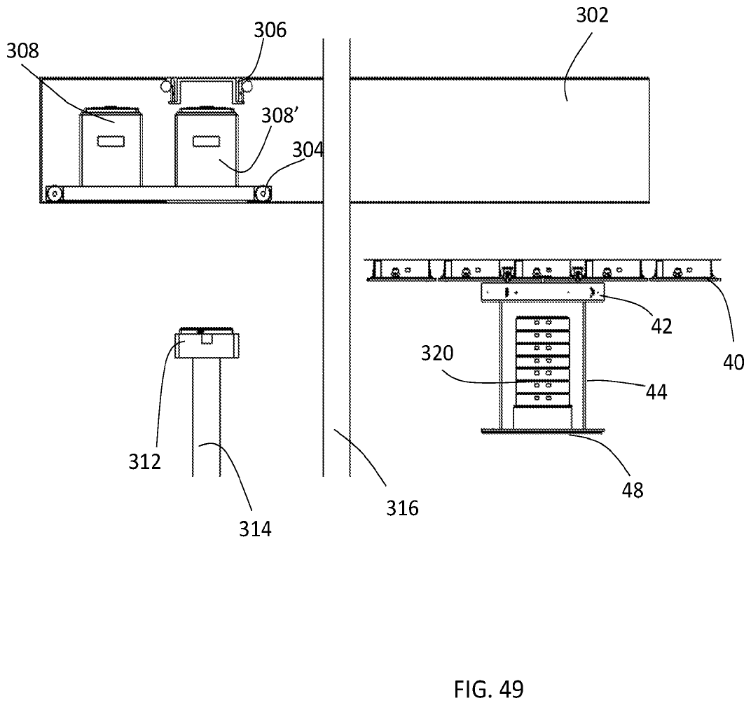

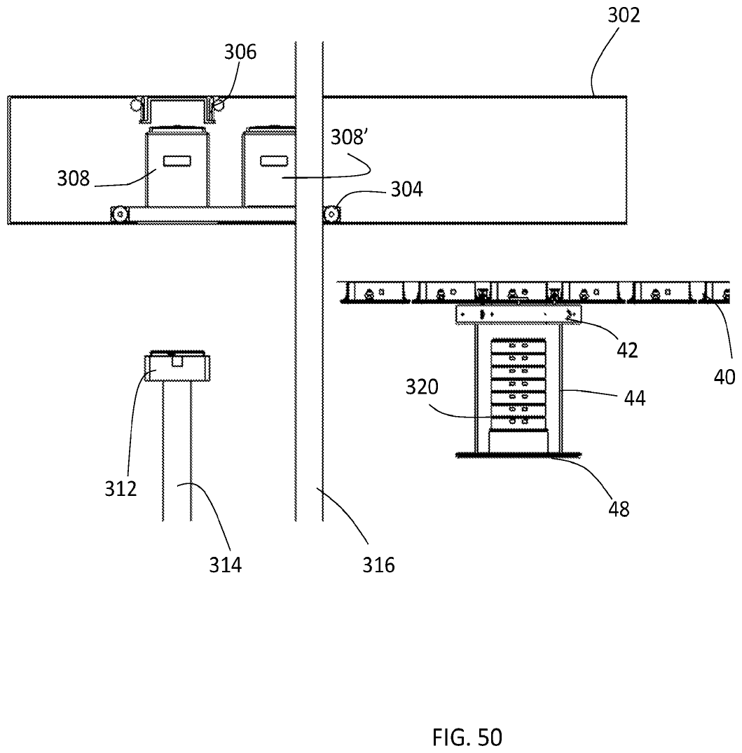

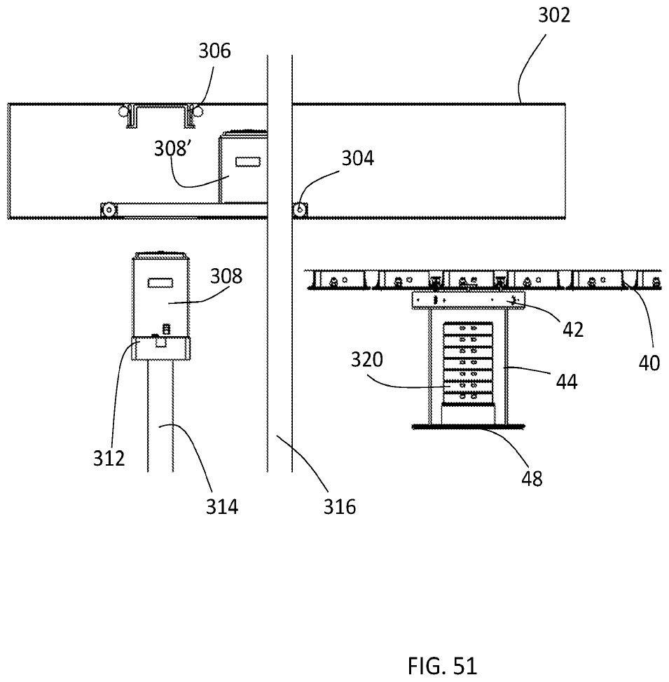

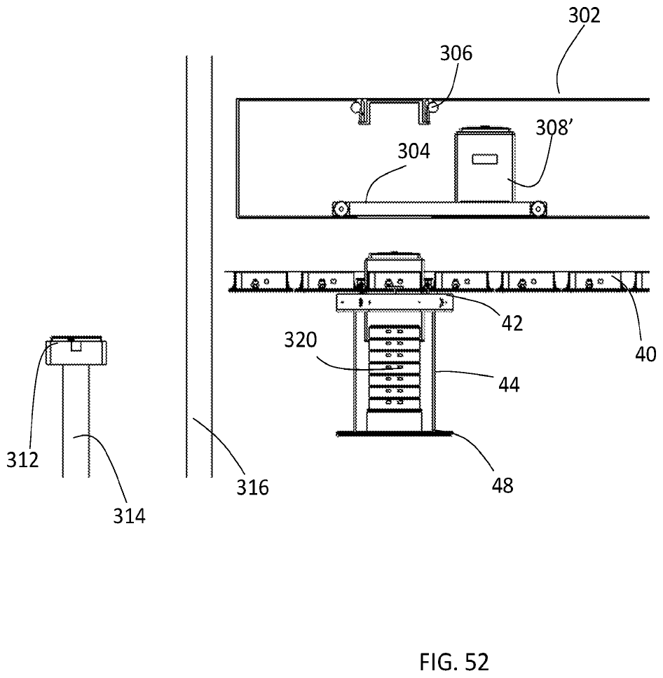

Next, as shown in FIG. 47, the sequence of operation may include installing an incoming delivery container 308′ onto the swap shuttle 304 by raising the external elevator 314 having a docking station 312 positioned. According to certain inventive embodiments, the external elevator 314 is actuated by a piston. The external elevator 314 may be a docking drone and may be positioned underneath or above the transfer tunnel 302. The transfer tunnel elevator 306 may also or alternatively be used to facilitate the transfer of the incoming container 308′ to the transfer tunnel 302, as shown in FIG. 48. It will be understood that latching and unlatching of the container 308′ may also be carried out using the delivery vehicle interface. Next, as shown in FIG. 49, the elevators 306 and/or 314 are retracted. Next, as shown in FIG. 50, the swap shuttle 304 is then shifted back toward the interior of the suspended automation system so that the outgoing loaded container 308 is positioned in alignment with the delivery interface 306 of the transfer tunnel 302. Next, as shown in FIG. 51, the outgoing loaded container 308 is removed from the swap shuttle 304 through the opening 303 by the external elevator 314 and docking station 312. It will also be understood that the container may be latched and unlatched by the system as necessary. On the docking station 312 and external elevator 314, the outgoing loaded container 308 is then moved to a second suspended automation system.

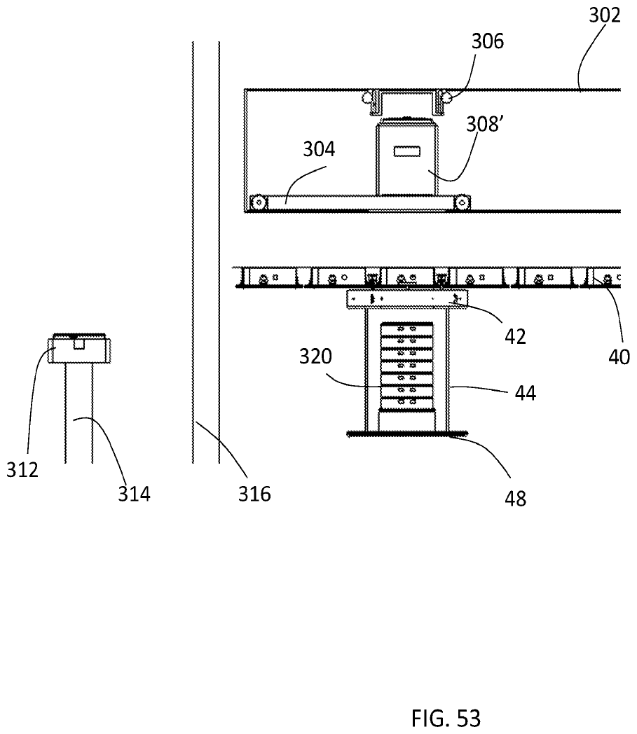

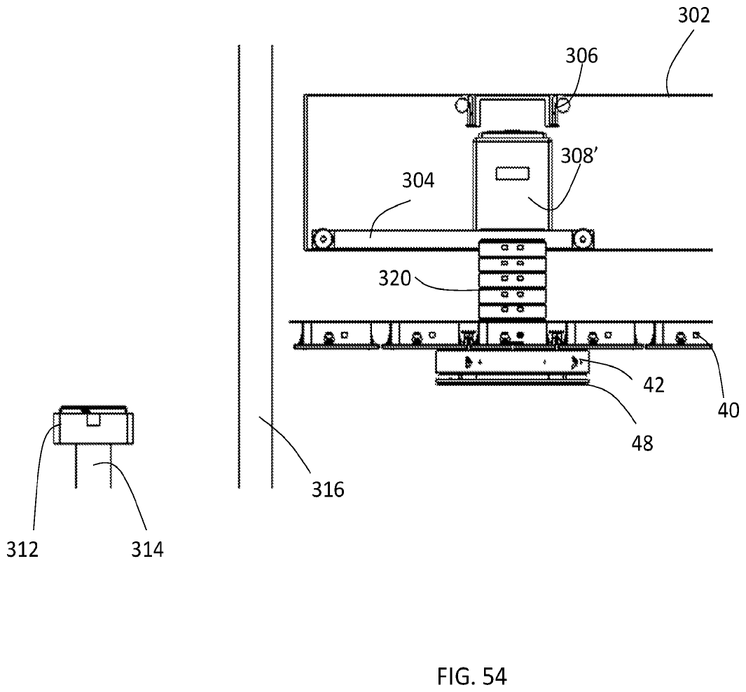

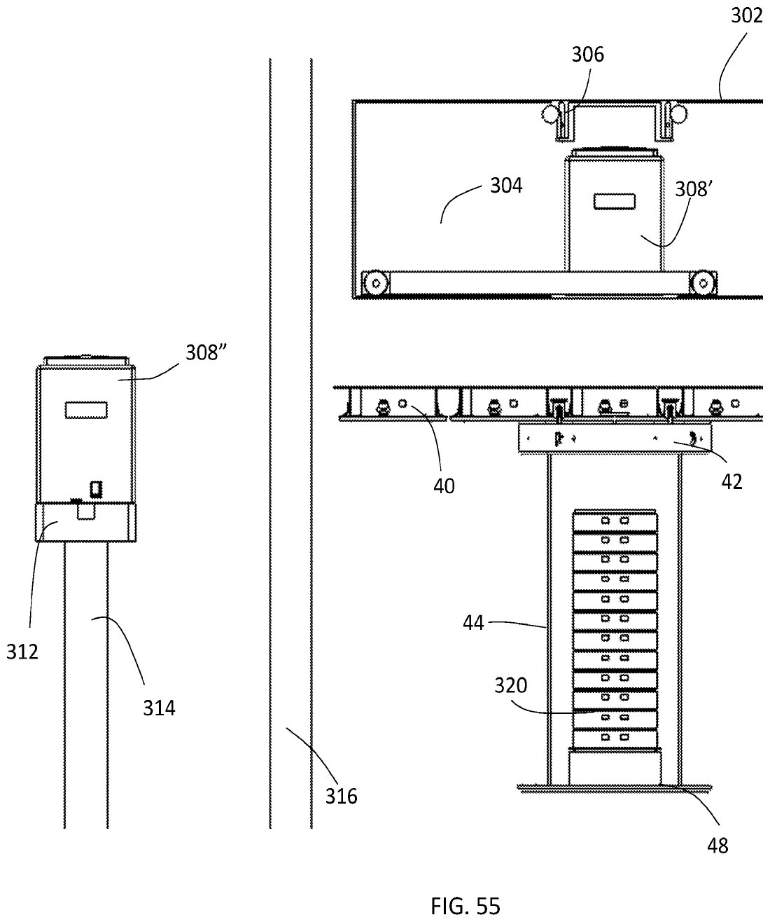

Next, as shown in FIG. 52, the transfer tunnel 302 is then retracted back to the inside of the wall 316. As shown in FIG. 53, the incoming container 308′ is then aligned with the elevator and delivery interface 306 by shifting of the swap shuttled 304. Next, as shown in FIG. 54, the stack of trays 320 is raised by the gantry 42 and cables 44 of the suspended automated system interior to the wall 316. It will be understood that the gantry could be empty with no trays loaded thereon. The trays 320 are aligned with the incoming container 308′. Next, as shown in FIG. 55, the trays that were in the incoming container 308′ are stacked onto the stack of trays 320 on the gantry 42. The cables 44 then lower the gantry 42, thereby lowering the trays from the incoming container 308′ so that those incoming trays are now part of the stack of trays 320. These trays 320 are then lowered into the suspended automation system. At the same time, a second incoming container 308″ outside the wall 316 is received by the exterior docking station 312 and elevator 314 from an external suspended automated system, which may be the second or a third suspended automated system. According to certain inventive embodiments, the operation sequence then repeats a plurality of iterations.

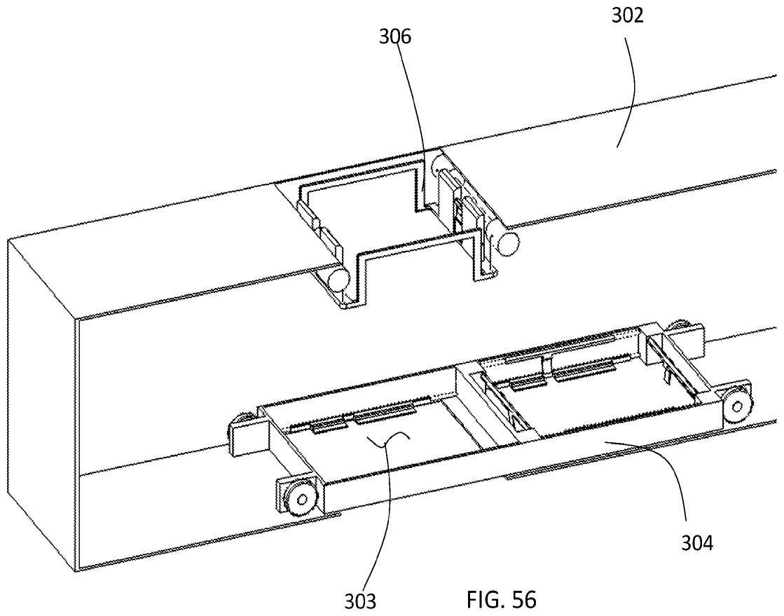

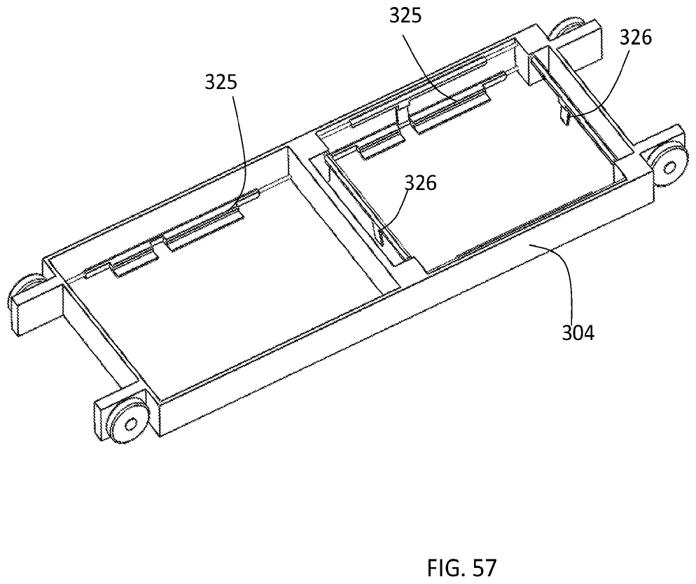

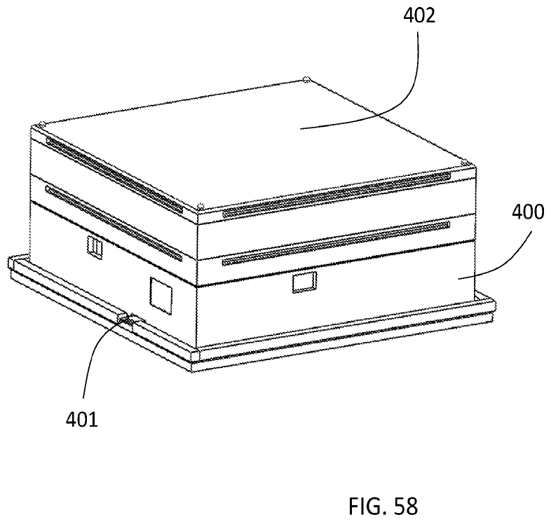

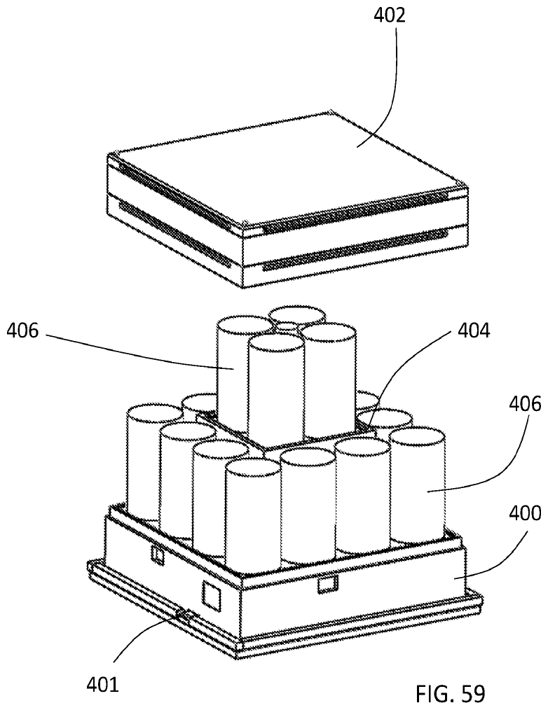

Further details of the transfer tunnel 302 and the swap shuttle 304 are show in FIGS. 56 and 57. In FIG. 56 the opening 303 in the transfer tunnel 302 is shown along with swap shuttle 304 positioned therein and the tunnel elevator and delivery interface 306 positioned therein. In FIG. 57, the delivery container latches 325 are shown (in a closed position) as well as the delivery container release mechanism 326 (shown in a retracted position).

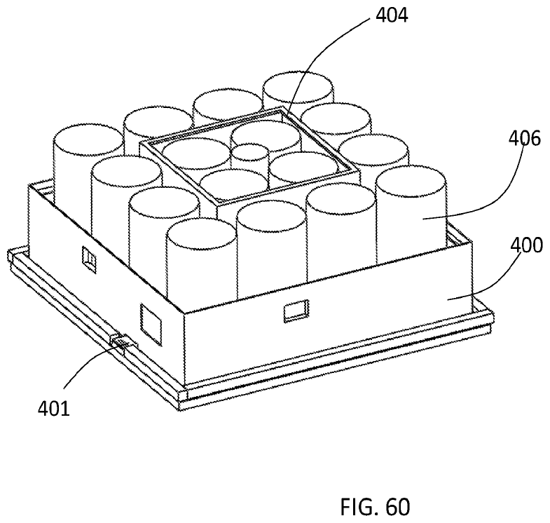

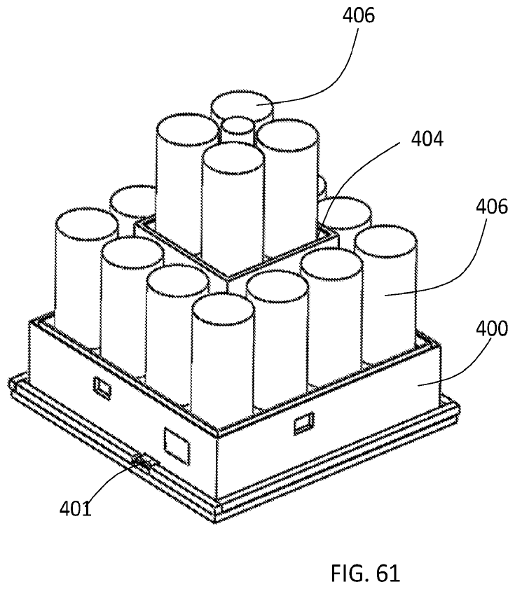

According to embodiments, as shown in FIGS. 58 and 59, storage trays 400 (130, 156, 320) for use with the inventive system include a cover 402. The cover is removable and attachable to the tray 400. According to certain inventive embodiments, the cover 402 is secured to the tray 400 by a plurality of latches 401. The latches 401 are actuated by the X-Y gantry system, according to certain inventive embodiments, or alternatively are actuated manually. According to certain inventive embodiments the covers 402 are stored, permanently or temporarily by the X-Y gantry system, and the trays 400 may be raised, lowered, and otherwise moved by the gantry system with or without the cover 402 positioned on the trays 400. According to embodiments, as shown in FIGS. 60 and 61, the trays 400 additionally include telescoping tiers 404 so that items 406 may be presented in a vertical manner alternatively or in addition to in a horizontal manner on the tray 400. According to certain inventive embodiments, the tiers 404 are actuated by springs or by pulling the inner-most tier by hand or with the cover 402. By providing multiple tiers provided on one tray, small items may be presented on a tray 400 without the risk of being lost or disorganized. According to certain inventive embodiments, a cover 402 restrains the telescoping tray tiers 404 in a retracted position (FIG. 60—shown without cover 402 for clarity) when the cover 402 is on the tray 400, thereby minimizing the volume of the tray 400. According to certain inventive embodiments, the cover 402 has latches for extending latching tray tiers. When the cover 402 is removed from the tray 400, the telescoping tiers 404 are extended, as shown in FIG. 61, to maximize visualization, presentation, and accessibility of the items 406 o the tray 400. The tiers 404 can be actuated when the platform 48 is lowered and the cover 402 is held by the X-Y gantry system.

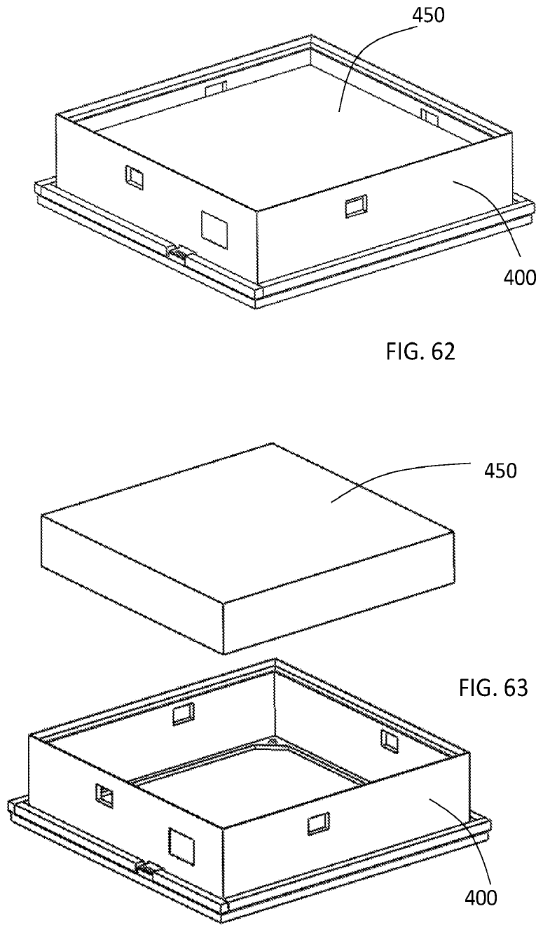

According to certain inventive embodiments, the suspended automation system provides battery storage for charging and use. That is, as shown in FIGS. 62 and 63, a plurality of batteries (shown generally as 450) are positioned within a tray 400. It will be understood that a plurality of trays 400 may be used to hold a plurality of batteries 45 such that an array of batteries is stored in a ceiling. According to certain inventive embodiments, the batteries 450 are in physical electrical connection to the tray 400 when stored in ceiling grid cells (as described above) for charging and use of the batteries 450. According to certain inventive embodiments, the batteries 450 are in inductive or direct electrical connection to the platform 48 when the batteries 450 are positioned thereon. According to certain inventive embodiments, such distributed batteries can be used to power a home, restaurant, business, or other building outfitted with an inventive X-Y gantry system.

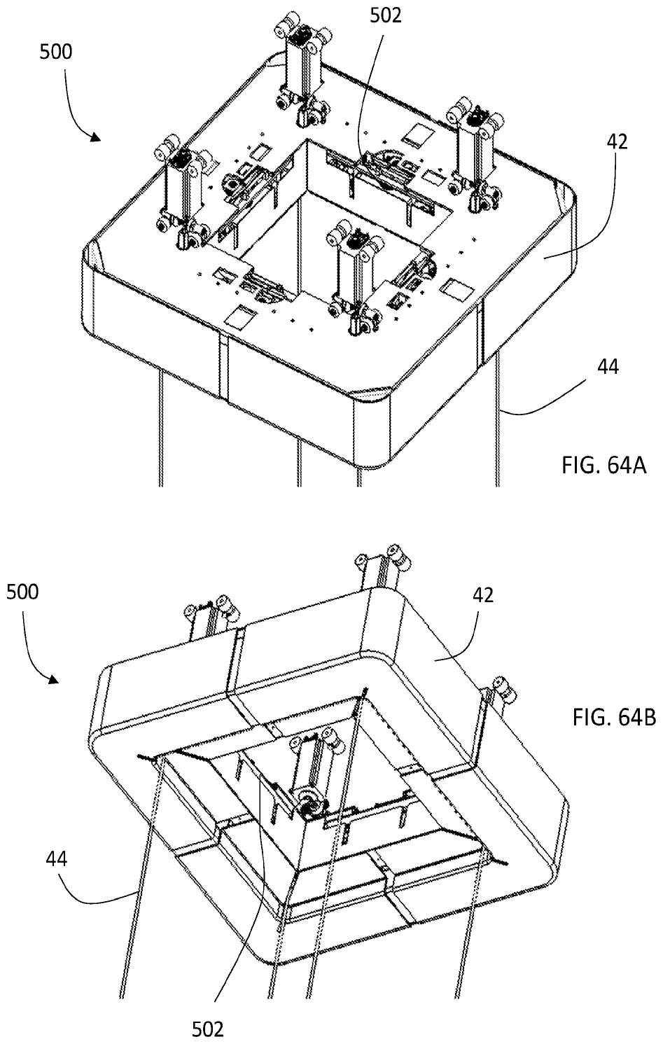

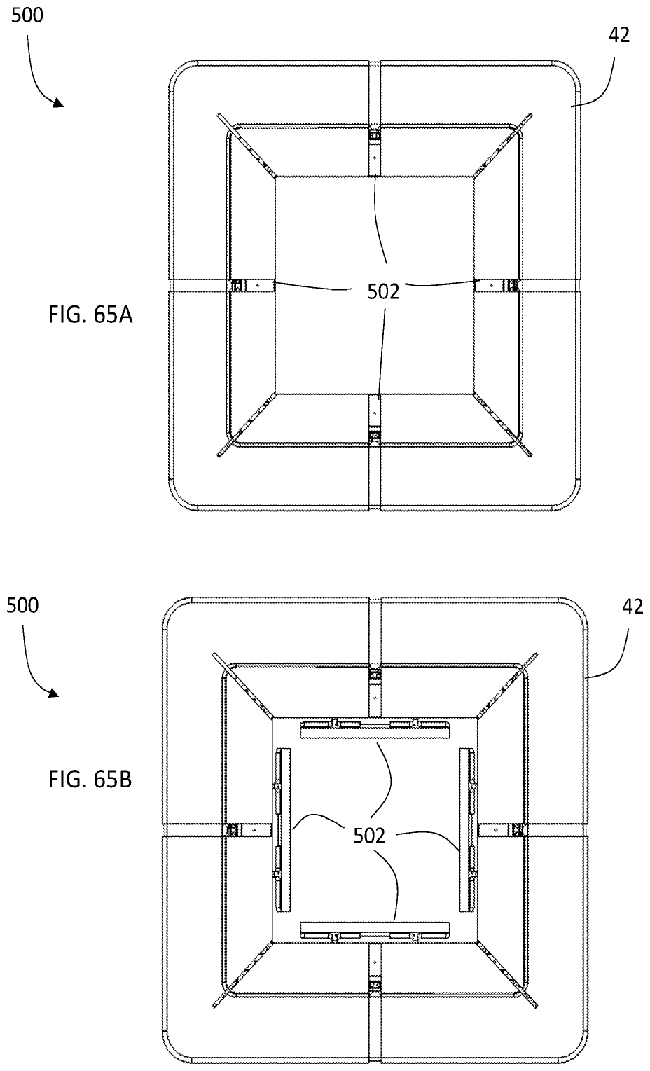

According to certain inventive embodiments, the inventive suspended automation system is provided with a system for cover manipulation 500 of the gantry 42 (described above), as shown in FIGS. 64A and 64B. The system for cover manipulation 500 provides the ability to stop and/or resist the vertical movement of the trays 400 (130, 156, 320) by enabling tensioning in the Z cables 44. According to certain inventive embodiments, the system for cover manipulation 500 are configured to latch and unlatch and support tray covers 402. According to certain inventive embodiments, the system for cover manipulation 500 includes a plurality of extendable and retractable stop bars 502. According to certain inventive embodiments, a stop bar 502 is provided on the inside of each of four walls of the gantry 42, as shown in the retracted position shown in FIG. 65A. The cover manipulation system 500 has variable extension distance by using the rotation function of the lift bars (detailed above). According to certain inventive embodiments, the stop bars 502 are retracted by springs. According to certain inventive embodiments, the stop bars 502 engage with latches on tray covers 402 to latch and unlatch the covers 402 from the trays 400. Additionally, the stop bars 502 are configured to hold the tray covers 402 in the gantry 42. According to certain inventive embodiments, the stop bars 502 engage with the top surface of the tray covers 402 to enable tensioning of the Z cables 44. The stop bars 502 are shown in an extended position in FIG. 65B.

According to certain inventive embodiments, the inventive suspended automation system includes an anti-sway system that is configured to prevent the platform 48 from swaying on its cables 44 during X-Y translation, acceleration, deceleration, or when the robotic arms are performing tasks. The inventive anti-sway system includes any of the following or a combination thereof. According to certain inventive embodiments, the anti-sway system includes a computer control system for controlling the X-Y gantry via algorithms similar to inverse pendulum controls. According to certain inventive embodiments, the anti-sway system includes the retractable stop bars in the X-Y Gantry (detailed above with respect to FIGS. 64A-65B) that enable the stack of trays 320 to be raised up against the stop bars 502 in order to put tension on the platform 48 cables 44. According to certain inventive embodiments, the anti-sway system includes telescoping trays 400 (as detailed above with respect to FIGS. 59-61) held against the stop bars 502 that enable the platform 48 to raise and lower while maintaining tension on the platform cables 44. According to certain inventive embodiments, the anti-sway system includes a floor-based robot that follows the X-Y Gantry 42 which has a retractable cable that attaches to the platform 48 to act as an anchor to put tension on the platform cables 44.

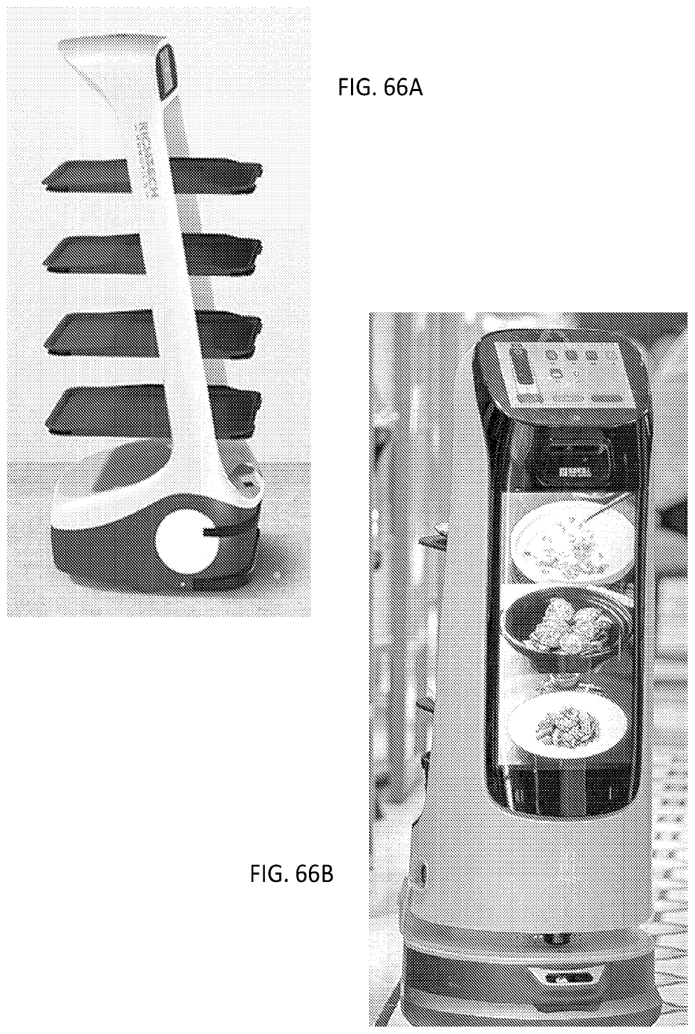

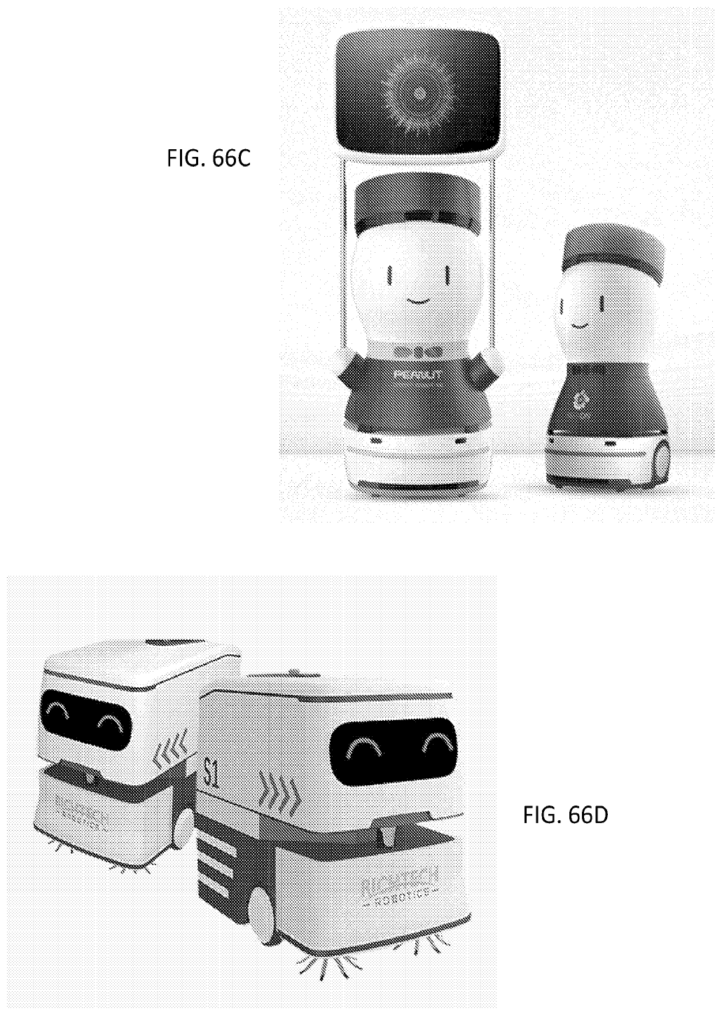

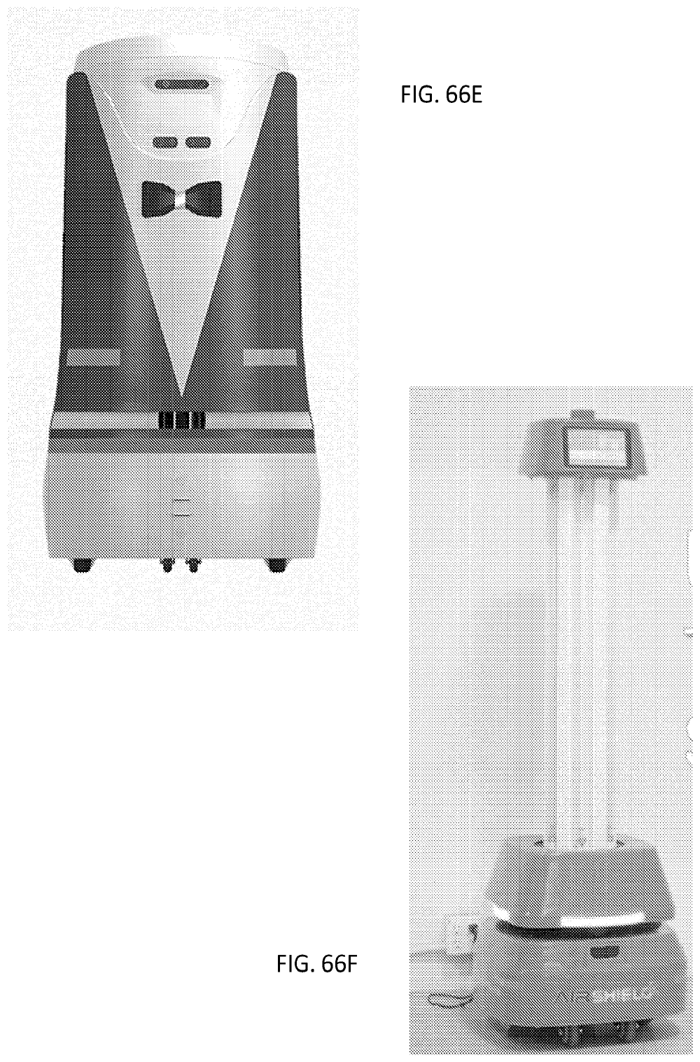

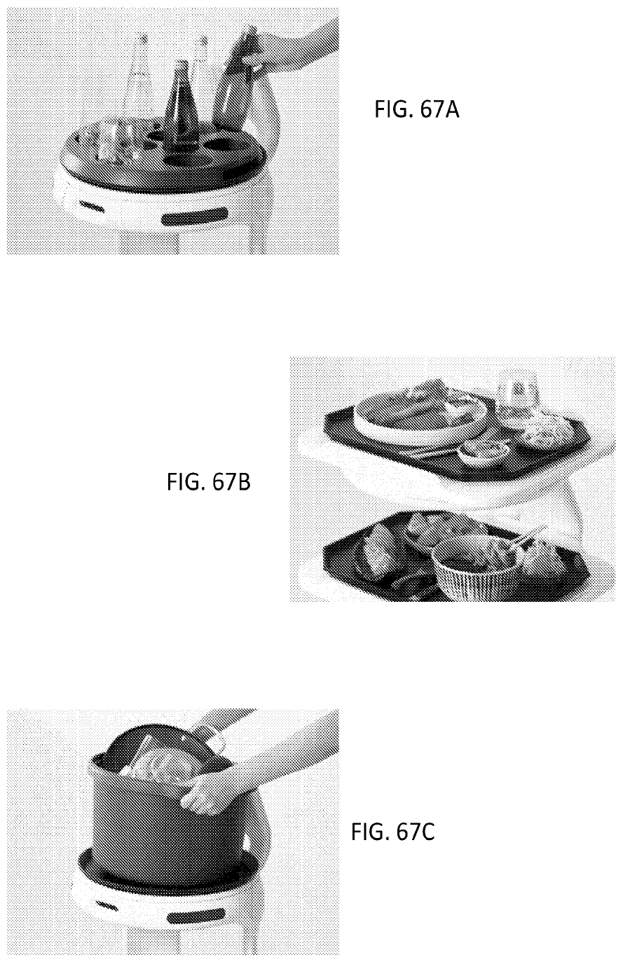

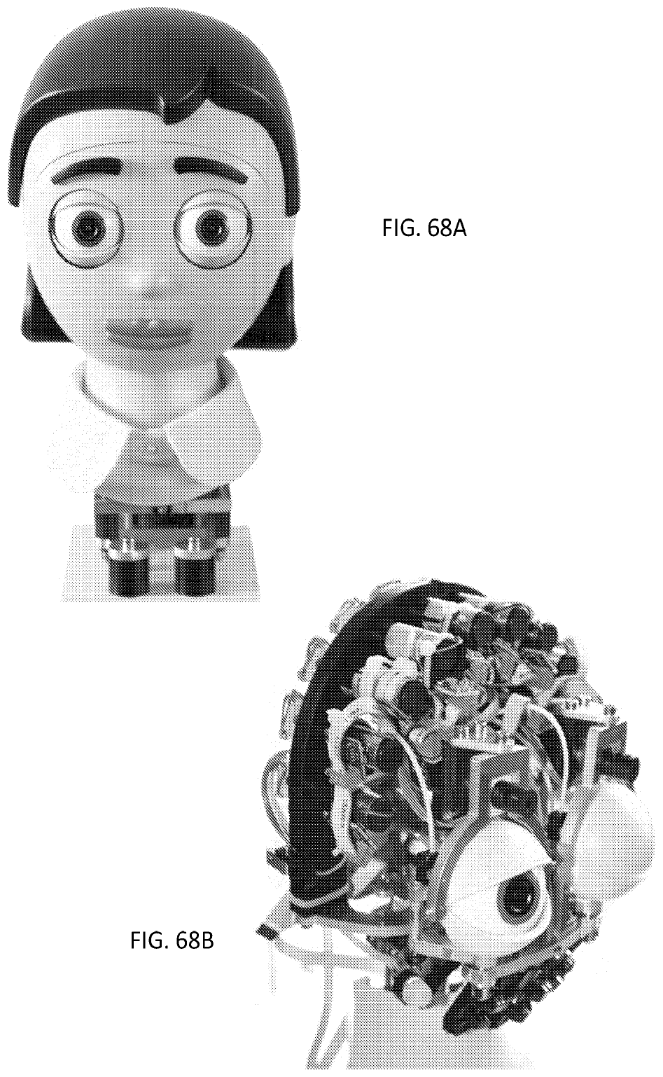

According to certain inventive embodiments, the inventive suspended automation system is configured to work in conjunction with a floor robot such as those shown in FIGS. 66A-66F. For example, the floor robots may serve as waiters in a restaurant setting and may deliver food and beverages to customers and return empty dishes from tables to the kitchen or a bussing and cleaning station. According to certain inventive embodiments, such floor robots are equipped with a drink serving unit (FIG. 67A), a food running unit (FIG. 67B), or a table bussing unit (FIG. 67C). According to certain inventive embodiments, the floor robots or platform 48 are equipped with robot waiter heads as shown in FIGS. 68A-68B.

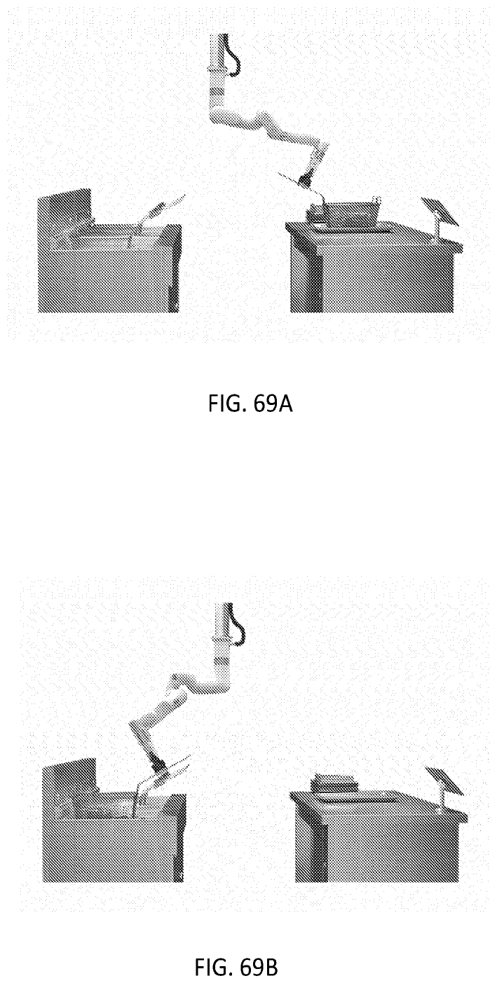

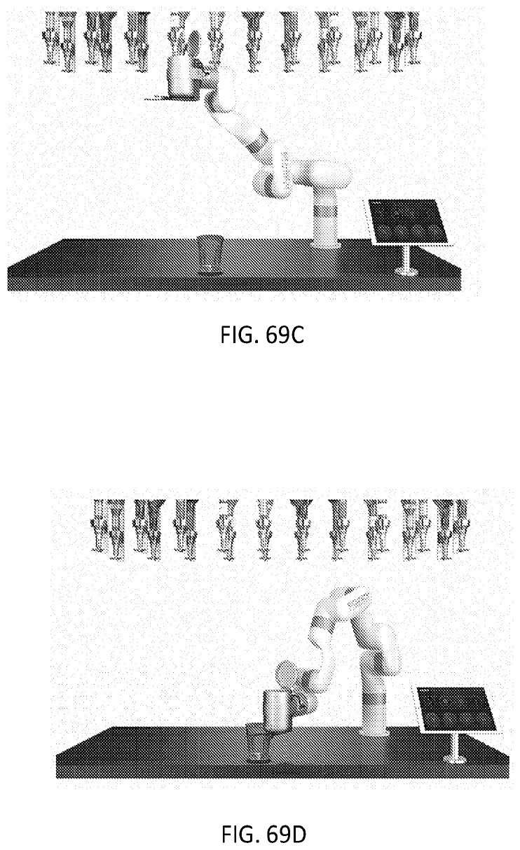

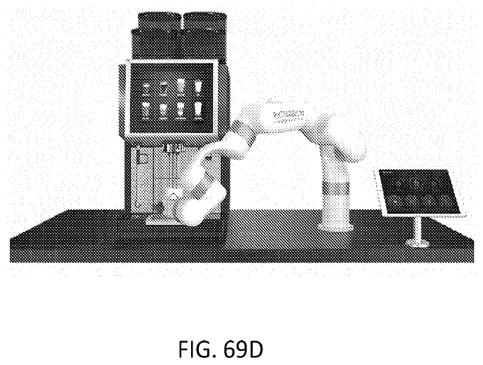

According to certain inventive embodiments, the inventive suspended automation system is configured to work in conjunction with at least one robotic arm, as shown in FIGS. 69A-69E. The robotic arms may be utilized in the kitchen to cook and/or prepare food (FIGS. 69A and 69B), at a bar (FIGS. 69C-69D) or drink counter (FIG. 69E) to prepare beverages, or at a bussing and/or cleaning station within the restaurant to sort garbage and clean used dishes. According to certain inventive embodiments, the robotic arm or system is configured to interact with a glass rinser module to rinse beverage vessels before filling. According to certain inventive embodiments of the present invention, a glass rinser, also known as a star sink, is a small sink configured to rinse a glass or cup by pressing the rim of the beverage container down into the glass rinser so that the rinser sprays a mist into the glass. According to certain inventive embodiments, the robotic arm or system is configured to interact with a set of small dish modules and condiment dispenser modules to portion and dole out desired condiment volumes. According to certain inventive embodiments, condiments are automatically dispensed from a plurality of condiment guns in a module such as the Homyl Professional Hamburger Sauce Gun available on Amazon.com. The condiment dispenser module is configured to dispense any condiment, including any of the following non-limiting examples: hot sauce, salsa, marinara sauce, mustard, soy sauce, sriracha, horseradish, Worcestershire sauce, fish sauce, relish, ketchup, honey mustard, BBQ sauce, tartar sauce, duck sauce, honey, ranch dressing, salad dressings, aioli, mayonnaise, olive oil, or a combination thereof. According to certain inventive embodiments, the condiments are dispensed into small dishes or directly on to food. According to certain inventive embodiments, the robotic arm or system is configured to interact with a spice or seasoning dispenser module, such as the TasteTro App enhanced Automated Spice Rack. According to certain inventive embodiments, the dispensed spices and seasonings may be dispensed into small dishes for providing to a customer, into large dishes for cooking and baking, or directly onto prepared food. According to certain inventive embodiments, the robotic arm or system is configured to interact with a bowl module, glass module, utensil module (such as the Dixie Ultra SmartStock automatic touchless fork dispenser by Georgia-Pacific), or napkin dispenser module. According to certain inventive embodiments, the robotic arm or system is configured to interact with a bulk food dispenser module, such as the Zevro triple canister cereal dispenser by Commercial Plus.

The foregoing description is illustrative of particular embodiments of the invention but is not meant to be a limitation upon the practice thereof. The following claims, including all equivalents thereof, are intended to define the scope of the invention.

1. A suspended automation system comprising:
a rail array secured to a ceiling;
a gantry;
a drive mechanism coupled to said gantry for transit of said gantry in an area of said rail array;
a platform suspended from said gantry; and
a plurality of storage modules located above said rail array, each of said plurality of storage modules having a volume for storage of an article and positioned within cells of said rail array.

2. The system of claim 1 wherein one of the storage modules is accessible from a roof or wall through a hatch in said roof or wall.

3. The system of claim 1 wherein said drive mechanism includes interspersed powered wheel modules and lifters.

4. (canceled)

5. The system of claim 1 wherein said gantry is automatically transferrable to a second rail array.

6. The system of claim 1 further comprising one or more robotic arms associated with said platform.

7. The system of claim 6 further comprising one or more counter-balances to said one or more robotic arms.

8. The system of claim 1 wherein at least one of said plurality of storage modules is an automation sub-system.

9. (canceled)

10. The system of claim 1 further comprising one or more cameras associated with said platform.

11. The system of claim 1 further comprising one or more sensors associated with said rail array, said gantry, or said platform.

12. The system of claim 1 further comprising cables between said gantry and platform, said cables being retracted with winches in said gantry to raise and lower said platform.

13. The system of claim 1 further comprising a gantry pivot for rotating said gantry.

14. The system of claim 1 further comprising a motorized platform pivotably mounted to said platform.

15. The system of claim 1 wherein said human or computer user interface is a display, touch screen tablet, auditory, smart phone, a joystick, or a combination thereof.

16. The system of claim 1 wherein the ceiling is part of a room or trellis.

17. The system of claim 1 wherein at least two of said plurality of storage modules stacked on one another forming a stack.

18. A process of performing an operation in a room area comprising operating a system of claim 1.

19. A process of retrieving an article in a room area comprising:
storing the article in a system having a rail array secured to a ceiling, a gantry, a drive mechanism coupled to said gantry for transit of said gantry in an area of said rail array, a platform suspended from said gantry, a controller with a human or computer user interface for selectively moving said gantry, and a plurality of storage modules located above said rail array, each of said plurality of storage modules having a volume for storage of an article and positioned within cells of said rail array;
requesting the article via the user interface; and
allowing sufficient time for said gantry to translate to one of said plurality of said storage modules, said storage module therein containing the article, retrieve said module containing the article, access the article, lower the article or module and optionally move the article or module to a user selected delivery point for retrieving the article in the room area.

20. The process of claim 19 wherein the delivery point is a transfer point for said gantry to a second area.

21. The process of claim 19 wherein the article is further manipulated by robotic arms associated with said platform prior to the delivery point.

22. The process of claim 19 wherein the article is collected through a hatch in a roof accessible by one of the stacked storage modules.
